(19) United States
(12) Patent Application Publication
(10) Pub. No.: US 2025/0204543 A1
(43) Pub. Date: Jun. 26, 2025

(54) SOY MILK AND RELATED PRODUCTS, AND METHODS OF PRODUCING THEREOF

(71) Applicants: Matthew Brett BEGEMANN, St. Louis, MO (US); Ratna MUKHERJEA, St. Louis, MO (US); Kathryn Nicole HAYDON, St. Louis, MO (US); Elizabeth Ann REIM, St. Louis, MO (US); Nicholas Frederick REITZ, St. Louis, MO (US); BENSON HILL HOLDINGS, INC., St. Louis, MO (US)

(72) Inventors: Matthew Brett BEGEMANN, St. Louis, MO (US); Ratna MUKHERJEA, St. Louis, MO (US); Kathryn Nicole HAYDON, St. Louis, MO (US); Elizabeth Ann REIM, St. Louis, MO (US); Nicholas Frederick REITZ, St. Louis, MO (US)

(21) Appl. No.: 18/852,766

(22) PCT Filed: Mar. 31, 2023
(86) PCT No.: PCT/US2023/017180

§ 371 Date: Sep. 30, 2024

Related U.S. Application Data
(60) Provisional application No. 63/326,748, filed on Apr. 1, 2022.

(51) Int. Cl. A23C 11/10; A23C 20/02; A23G 9/42; A23L 11/65

(52) U.S. Cl. CPC A23C 11/106; A23C 20/025; A23G 9/42; A23L 11/65

(57) ABSTRACT

The present disclosure relates generally to soybean products derived from high protein soybeans, and more specifically to soy milk compositions having high protein content and methods of preparing such soy milk compositions. The present disclosure also relates to uses of the soy milk compositions in food products. The present disclosure also relates to uses of the soy milk compositions in food products.

### CROSS-REFERENCE TO RELATED APPLICATIONS

This application claims priority benefit of U.S. Provisional Patent Application No. 63/326,748, filed Apr. 1, 2022, which is hereby incorporated herein by reference in its entirety.

### FIELD

The present disclosure relates generally to soybean products derived from high protein soybeans, and more specifically to soy milk, soy yogurt, and soy frozen dessert compositions having high protein content, as well as methods of preparing such compositions. The present disclosure also relates to uses of the soy milk compositions in food and/or beverage products.

### BACKGROUND

Due to increasing concern around the sustainability of the consumption of animal-sourced products, there has been a shift from dairy products and growing consumer demand for plant-based dairy substitutes. However, many existing plant-based dairy substitutes on the market do not have desirable nutritional, textural, and/or flavor characteristics, especially in comparison to dairy products. In particular, many plant-based dairy substitutes, such as almond and oat milks, have significantly less protein than the corresponding dairy products. Among plants being researched as suitable alternative protein sources for dairy product, soybeans represent an attractive renewable source of protein for use in foodstuffs, as soybean protein content comes closest to approximating the protein content in dairy products. However, the protein content of soy milk generated from commodity soybeans is often significantly less than that of dairy milk. Thus, while plant-based dairy substitutes with increased protein concentration exist, including existing soy-based dairy substitutes, these products require the addition of extraneous ingredients, such as protein isolate, to increase the nutritional content. Additionally, the flavor profile of soybeans differs substantially from that of dairy milk, which may be undesirable to certain consumers.

Thus, there is a need not only for soy compositions having high protein content and desirable flavor profiles, but also for streamlined and inexpensive methods of producing these high-protein soy compositions, without the need for supplementation with extraneous protein to increase nutritional content or sugar and other flavoring agents to mask off-putting flavor attributes of the soybean derived products.

### BRIEF SUMMARY

In one aspect, provided herein are soy milk compositions, soy yogurt compositions and soy frozen dessert compositions having high protein content. In another aspect, provided herein are methods for preparing the soy milk compositions, soy yogurt compositions and soy frozen dessert compositions having high protein content as described herein.

In one aspect, provided herein is a soy milk composition, comprising (I) at least about 4 g of soy protein per 100 mL of liquid volume; and (II) at least one of (i)-(vi): (i) at least 0.5 g oleic acid per 100 mL of liquid volume; (ii) less than or equal to about 30 mg of raffinose per 100 mL of liquid volume; (iii) less than or equal to about 100 mg of stachyose per 100 mL of liquid volume; and (iv) less than or equal to about 0.5 mg total glycitein compounds per 100 mL of liquid volume.

In another aspect, provided herein is a soy milk composition, comprising (i) less than or equal about 130 calories per 8 fluid ounces; (ii) at least about 13 g of protein per 8 fluid ounces; and (iii) at least about 4 g of monounsaturated fats per 8 fluid ounces.

In yet another aspect, provided herein is a soy milk composition, comprising (i) less than or equal to about 80 calories per 8 fluid ounces; (ii) at least about 8 g of protein per 8 fluid ounces; and (iii) at least about 4 g of monounsaturated fats per 8 fluid ounces.

In one aspect, provided herein is a method for producing a soy milk composition, comprising a) providing soybeans, wherein the soybeans comprise at least about 40% soy protein on a dry weight basis; b) drying, and optionally cracking, the soybeans to provide dried soybeans; c) dehulling the dried soybeans to provide soy grits; d) grinding the soy grits in hot water to provide a soy slurry; e) heating the soy slurry; f) cooling the soy slurry; and g) filtering the soy slurry, thereby providing the soy milk composition, wherein the soy milk composition comprises at least about 0.4 g of soy protein per 1 g of soy solids. In another aspect, provided herein is a soy milk composition obtained by or obtainable from the methods of producing a soy milk composition as described herein.

In another aspect, provided herein is a method for preparing a soy yogurt composition, comprising a) providing a soy milk composition as described herein or obtained according to a method as described herein, b) heating the soy milk composition to provide a heated soy milk composition; c) cooling the heated soy milk composition; d) adding a bacterial starter culture, and optionally a coagulant, to the heated soy milk composition to provide soy culture mixture; e) incubating the soy culture mixture at an incubation temperature for a suitable time to provide a fermented soy composition; and f) straining the fermented soy composition to remove excess liquid, thereby providing the soy yogurt composition.

In yet another aspect, provided herein is a soy yogurt composition obtained by or obtainable from the methods of producing a soy yogurt composition as described herein.

In another aspect, provided herein is a method for preparing a soy frozen dessert composition, comprising a) providing a soy milk composition as described herein or obtained according to a method as described herein, b) combining the soy milk composition with sugar, a thickening agent, and optionally one or more flavoring agents, to provide a frozen dessert base mixture; c) heating the frozen dessert base mixture to provide a heated frozen dessert base mixture; d) chilling the heated frozen dessert base mixture, optionally straining the heated frozen dessert base mixture prior to chilling, to provide a chilled frozen dessert base mixture; and e) churning the chilled frozen dessert base mixture at a suitable time and temperature to provide a soy frozen dessert composition.

In still yet another aspect, provided herein is a soy frozen dessert composition obtained by or obtainable from the methods of producing a soy frozen dessert composition as described herein.

In one aspect, provided herein is a food product, a beverage product, a dietary supplement product or other product, comprising a soy milk composition as described herein.

### DESCRIPTION OF THE FIGURES

The present application can be understood by reference to the following description taken in conjunction with the accompanying figures.

FIG. 1 depicts a plot of protein content of soy milks prepared from various soybean varieties having different protein content as compared the protein content of the source soybean varieties.

FIG. 2 shows an exemplary process for the preparation of a soy milk composition.

FIG. 3 shows an exemplary process for the preparation of a soy yogurt composition from soy milk compositions.

FIG. 4 shows an exemplary process for the preparation of a soy frozen dessert composition from soy milk compositions.

FIG. 5 shows a plot of astringency, as measured on a 15-point scale, vs. seed glycitein and glycitin content (in ppm).

FIG. 6 shows a plot of consumer panelists' description of the thickness of a soy milk vs. the protein content of the soybean variety from which the soymilk was produced.

FIG. 7 shows plots of consumer panelists' description of the thickness of a soy milk (top), perceived viscosity as assessed by trained panelists on a 15-point scale (middle) or viscosity in centipoise (bottom), vs. the percent of soy milk solids in different soy milks.

### DETAILED DESCRIPTION

The following description is presented to enable a person of ordinary skill in the art to make and use the various embodiments. Descriptions of specific compositions, methods, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The present disclosure addresses the need for improved soy milk compositions having high protein content as well as good flavor and texture profiles, as well as downstream food and/or beverage products of the soy milk, such as soy yogurt compositions and soy frozen dessert compositions. The present disclosure addresses this need by providing methods of preparing high protein soy milk compositions from soybean cultivars having higher protein content than commodity soybeans or other soybean varieties currently used for commercial soy products.

The soy milk and downstream products, including for example, soy yogurt and soy frozen desserts, are obtained from soybeans having high protein content. The soybeans having high protein content may also possess additional favorable characteristics for consumers, including high levels of heart healthy oils, and low levels of indigestible oligosaccharides (e.g., raffinose and stachyose), as well as better texture and flavor profiles.

The compositions of the present disclosure are obtained by processing soybeans having high protein content into soy milk and further processing the soy milk having high protein content into soy yogurt and soy frozen dessert, both having similarly high protein content.

### A. Methods of Producing Soy Milk Compositions, and Related Food/Beverage Products

In one aspect, provided herein are methods of producing soy milk compositions, and other products, such as soy yogurt and soy frozen dessert compositions, that may be derived from the soy milk compositions. In some embodiments, the soy milk compositions have a high protein content, produced from soybean varieties having high protein contents in addition to other favorable nutritional and flavor profiles as described herein.

### I. High Protein Soybeans

As described above, provided herein are soy milk compositions having high protein content that are derived from soybeans having high initial protein contents, as well as methods of processing the same.

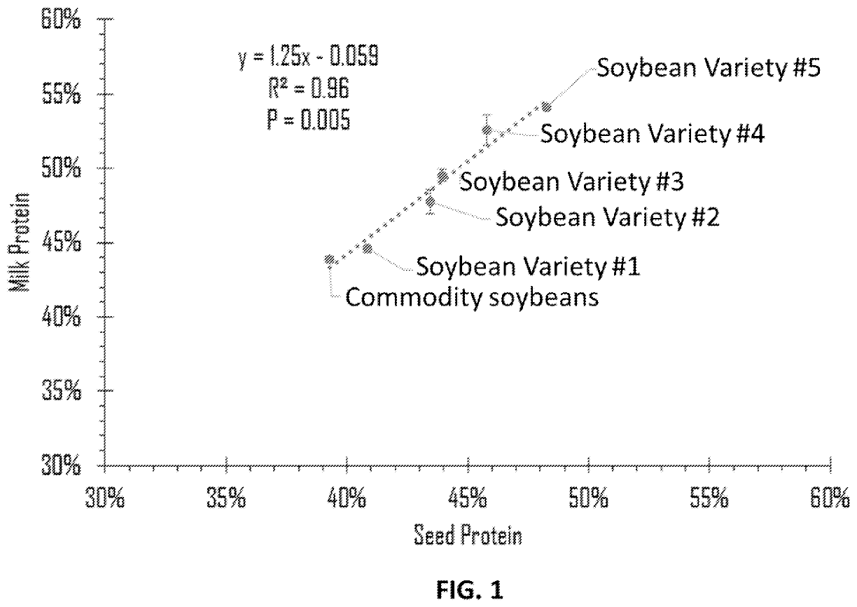

FIG. 1 illustrates an exemplary plot of the protein content of soy milks (expressed as a percentage of the soy milk solids) relative to the protein contents of soybeans from which the soy milks were produced. As shown in FIG. 1, the protein content in the soy milk is directly proportional to the protein content initially present in the soybeans, and, thus, the protein content of any single origin soy milk product is limited to the initial protein content of the source soybeans.

In some embodiments, the soybeans of the present disclosure have high protein contents, which enable the production of high protein soy milk compositions, and other related products, such as high protein soy milk yogurt compositions and high protein frozen soy milk compositions, as described for the methods of the present disclosure.

In some embodiments, the protein content of the soybeans having a high protein content may be described as average protein content of the soybeans. In certain embodiments, the protein content of the soybeans having a high protein content may be an average protein content of the soybeans for a given mass of soybeans (e.g., per 1 kilogram mass). In other embodiments, the protein content of the soybeans having a high protein content may be characterized by a distribution of protein contents.

In some embodiments, the soybeans having high protein content may be characterized by protein content as determined by the Kjeldahl method. In other embodiments, the soybeans having high protein content may be characterized by protein content as determined by near-infrared spectroscopy (NIRS). In yet other embodiments, the soybeans having high protein content may be characterized by protein content as determined by elemental analysis (e.g., the Dumas combustion method).

In still other embodiments, providing soybeans having a high protein content may be achieved by sorting and/or harvesting practices selective for soybeans having high protein content. For example, in some embodiments, the methods provided herein comprise separating a plurality of soybeans according to protein content to provide at least a portion of soybeans having a high protein content from the plurality of soybeans. In some embodiments, the separation of the plurality of soybeans according to protein content is a batch process. In some embodiments, the separation of the plurality of soybeans according to protein content is a continuous process. In certain embodiments, the separation of the plurality of soybeans according to protein content is a high-throughput process. In some embodiments, the separation of the plurality of soybeans according to protein content comprises determining protein content of the plurality of soybeans by NIRS. In some embodiments, the sorting of soybeans as described herein is performed manually. In other embodiments, the sorting of soybeans as described herein is performed mechanically.

In other embodiments, the soybeans used in the methods herein are obtained by harvesting soybeans according to height gradient on the soy plant, e.g., harvesting soybeans growing higher on a given soy plant. In some embodiments, the harvesting soybeans according to the height of the soy plant(s) provides soybeans having a high protein content. In some embodiments, the harvesting of soybeans as described herein is performed manually. In other embodiments, the harvesting of soybeans as described herein is performed mechanically. In some embodiments, the step of providing soybeans having a high protein content comprises (i) separating a plurality of soybeans according to protein content to provide at least a portion of soybeans having a high protein content from the plurality of soybeans; (ii) harvesting soybeans according to the height of the soy plant(s) to provide soybeans having a high protein content; or (iii) a combination of (i) and (ii).

In some embodiments, the soybeans utilized in the present disclosure have high protein content. In some embodiments, the protein content of the soybeans is determined as a weight percentage of the whole bean or as a weight percentage of the dehulled bean.

In some variations of the foregoing embodiments, at least a portion of the soybeans used has a protein content of at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, at least a portion of the soybeans used has a protein content of at least about 42% soy protein on a dry weight basis. In some variations, at least a portion of the soybeans used has a protein content of at least about 45% soy protein on a dry weight basis. In other variations, at least a portion of the soybeans used has a protein content of at least about 48% soy protein on a dry weight basis. In some variations, at least a portion of the soybeans used has a protein content of between about 42% and about 60%, between about 45% and about 60%, or between about 48% and about 60%.

In other variations of the foregoing embodiments, the soybeans used have an average protein content comprising at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the soybeans used have an average protein content of at least about 42% soy protein on a dry weight basis. In some variations, the soybeans used have an average protein content of at least about 45% soy protein on a dry weight basis. In other variations, the soybeans used have an average protein content of at least about 48% soy protein on a dry weight basis. In some variations, the soybeans used have an average protein content of between about 42% and about 60%, between about 45% and about 60%, or between about 48% and about 60%.

In yet other variations of the foregoing embodiments, the majority of the soybeans used has a protein content of at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the majority of the soybeans used has a protein content of at least about 42% soy protein on a dry weight basis. In some variations, the majority of the soybeans used has a protein content of at least about 45% soy protein on a dry weight basis. In other variations, the majority of the soybeans used has a protein content of at least about 48% soy protein on a dry weight basis. In some variations, the majority of the soybeans used has an average protein content of between about 42% and about 60%, between about 45% and about 60%, or between about 48% and about 60%.

In some embodiments, the soybeans having a high protein content as used in the methods provided are distinguished from commodity soybeans. Commodity soybeans may have a protein content of less than 40%, or between about 35% and about 40%, on a dry weight basis. The commodity soybeans may also have one or more additional properties: (i) an oil content of between about 15% and about 25% on a dry weight basis; (ii) a moisture content of between about 10% and 15%; (iii) a seed weight of between 10 g and 20 g per 100 seeds; (iv) a lysine content of between 5% and 10%, expressed as a percentage of the 18 primary amino acids; and (v) an essential amino acid content of between 10% and 20%, expressed as a percentage of the 18 primary amino acids. Similarly, the high protein soy milks, soy yogurts, and frozen soy compositions (soy frozen desserts) obtained from the soybeans having a high protein content described herein are distinguished from soy protein products obtained from commodity soybeans, such as soy milk, soy yogurt, and/or soy frozen desserts.

The percent composition of a given component in a soybean or sample of soybeans may be described on an “as-is” basis or on a “dry-weight” basis. The percent composition of a given component may be converted between an “as-is” basis and a “dry-weight” basis using the following equation:

$$protein content ( dry weight basis , \% ) = \frac{protein content ( as - is basis , \% )}{( ( 100 \% ) - ( moisture content , \% )} \qquad ( Eq . 1 )$$

The word “protein” in the above equation may be interchanged with any other soybean component for which conversion between an “as-is” and a “dry-weight” basis is needed, including, e.g., oil. The moisture content of a soybean or soybean product may be determined using any suitable methods or techniques known in in the art. See e.g., Eys, J. E. Van. Manual of Quality Analyses for Soybean Products in the Feed Industry, 2^{nd} ed. U.S. Soybean Export Council.

The soybeans having high protein content may also possess favorably high levels of heart-healthy monounsaturated fatty acids (or monounsaturated fats) or polyunsaturated fatty acids (or polyunsaturated fats). In some embodiments, the soybeans as utilized herein have low levels of saturated fatty acids.

Commodity soybeans, for example, may contain less than 25% w/w oleic acid out of the total fatty acids present in the soybeans. In some embodiments the soybeans as provided herein have high oleic acid content. In other embodiments, the soybeans comprise at least about 30%, at least about 40%, at least about 50%, at least about 60%, or at least about 70% w/w oleic acid of the total fatty acid content. In certain embodiments, the soybeans comprise at least about 70% of oleic acid of the total fatty acid content. In other embodiments, the soybeans as utilized herein have low linoleic acid content. In some embodiments the soybeans utilized herein have high oleic acid content and low linoleic acid content.

The soybeans comprising high protein content as employed by the methods of the present disclosure may be further characterized by one or more additional components present in the soybeans, such as oligosaccharide contents. The soluble carbohydrate component of soybeans is primarily comprised of three major sugars: the disaccharide sucrose, and the oligosaccharides raffinose and stachyose. Of the three, only sucrose is nutritionally useful and can be fully digested by monogastric animals. Raffinose and stachyose are considered anti-nutritional units because they cannot be digested due to the lack of α-galactosidase activity in the gut of monogastric animals.

In some embodiments, the soybeans having a high protein content may also comprise low raffinose and/or stachyose content. In some embodiments, the soybeans of the present disclosure comprise less than or equal to about 0.13%, less than or equal to about 0.11%, less than or equal to about 0.1%, less than or equal to about 0.07%, less than or equal to about 0.06%, less than or equal to about 0.03%, or less than or equal to about 0.01% raffinose on a dry weight basis. In other embodiments, the soybeans of the present disclosure comprise between about 0% to about 0.13% raffinose on a dry weight basis. In some embodiments, the soybeans of the present disclosure comprise about 0.01%, 0.03%, 0.06%, 0.07%, 0.10%, 0.11% and 0.13% raffinose on a dry weight basis, including all integers and fractions thereof. In some embodiments, the soybeans of the present disclosure comprise less than or equal to about 0.13%, less than or equal to about 0.11%, less than or equal to about 0.1%, less than or equal to about 0.07%, less than or equal to about 0.06%, less than or equal to about 0.03%, or less than or equal to about 0.01% stachyose on a dry weight basis. In other embodiments, the soybeans of the present disclosure comprise about 0.02%, 0.05%, 0.07%, 0.12%, 0.16%, 0.21%, 0.26%, 0.34%, 0.38%, 0.48%, 0.49%, 0.51%, 0.55%, 0.59%, 0.63%, 0.67%, 0.78%, 0.80%, 0.85%, 0.91%, 0.96%, 1.12%, 1.19%, 1.23%, 1.28%, 1.33%, 1.38%, 1.45%, 1.49%, 1.56%, 1.57%, 1.63%, 1.68%, 1.71%, 1.73%, 1.75% stachyose on a dry weight basis, including all integers and fractions thereof. In some embodiments, the soybeans having a low raffinose and stachyose content comprise a combined raffinose and stachyose content of between about 0.02% and 1.75%.

In some embodiments, the soybeans having high protein content may be described in terms of their content of various intrinsic flavor components, associated with positive or negative flavor attributes in soy products. Such intrinsic flavor components may include, for example, trypsin inhibitor, lipoxygenase, saponins, and/or total glycitein compounds.

In some embodiments, the soybeans having high protein content may have low total glycitein compound content. Total glycitein compounds may include, for example, the algycone glycitein and its glucoside derivatives, such as glycitin, 6″-O-malonylglycitin, and 6″-O-acetylglycitin. In some embodiments, the soybeans comprise less than or equal to about 80 mg, less than or equal to about 75 mg, less than or equal to about 70 mg, less than or equal to about 60 mg, less than or equal to about 50 mg, less than or equal to about 45 mg, or less than or equal to about 40 mg total glycitein compounds per kilogram of soybeans. In some embodiments, the soybeans comprise less than milligram amounts of total glycitein compounds per kilogram of soybeans. In other embodiments, the soybeans comprise undetectable amounts of total glycitein compounds per kilogram of soybeans.

It should be recognized that the majority of total glycitein compounds is contained within the hypocotyl of the soybeans. As a step in the process for preparing any of the soy milk compositions, and thus also downstream soy yogurt compositions and soy frozen dessert compositions as described herein, the soybeans are dehulled. As such, the total glycitein compounds of any soy compositions produced from the soybean varieties as described herein may possess even lower or undetectable amounts of total glycitein compounds.

In some embodiments, the soybeans having a high protein content as described herein may be further characterized by their color, especially their hilum color. The hila may range in color from black, brown, yellow, white and clear. The color of the soybean hila may affect the resulting color of any soy products produced therefrom. For example, hila colors that are lighter (e.g, yellow, white or clear) may be favored for producing white soy milk compositions and other soy products. In some embodiments, the hilum color of the soybeans having high protein content as described herein is yellow, white or clear.

It should be recognized that the soybean varieties having high protein content utilized herein may possess favorable content(s) of at least one of the following: oleic acid, linoleic acid, raffinose, stachyose, and/or total glycitein compounds. In some embodiments, the soybeans having high protein content have high oleic acid content and low linoleic acid content. In other embodiments, the soybeans having high protein content have low raffinose and/or stachyose contents. In still other embodiments, the soybeans having high protein content have high oleic acid content and low raffinose and/or stachyose contents.

In some embodiments, the soybeans have a favorable trait package associated with a particular soybean variety.

In some embodiments, suitable soybeans used to produce the compositions herein include those described in U.S. Pat. No. 11,051,478, which is hereby incorporated herein by reference with respect to columns 5-6 on page 4, and column 37 on page 20. In some embodiments, suitable soybeans used to produce the compositions herein are obtained from a plant or seed of soybean cultivar 2705849, wherein a representative sample of seed of said cultivar is deposited under NCMA No. 202012120. Soybean cultivar 2705849 is an early-group I maturity variety. Additionally, soybean cultivar 2705849 is resistant to Soybean Cyst Nematode Race 3. In some embodiments, soybean cultivar 2705849 is characterized by high oleic acid (e.g., about 79.9%), and low linolenic acid (e.g., about 1.7%), where the percentages are measured as a percentage of the total fats (unsaturated and saturated fats). In some embodiments, at least about 70% by weight of the total fatty acid in the soybean is oleic acid. In some embodiments, the soybeans have a protein content of at least about 40% on a dry weight basis, and at least about 70% by weight of the total fatty acid in the soybean is oleic acid. In some embodiments, the soybeans have a protein content of at least about 40% on a dry weight basis, a stachyose content of less than about 4.5% on a dry weight basis, a raffinose content of less than about 1% on a dry weight basis, and at least about 70% by weight of the total fatty acid in the soybean is oleic acid. In some embodiments, the soybeans have a protein content of at least about 40% on a dry weight basis, a stachyose content of less than about 4.5% on a dry weight basis, a raffinose content of less than about 1% on a dry weight basis, less than about 225 mg/kg of total glycitein compounds on a dry weight basis, and at least about 70% by weight of the total fatty acid in the soybean is oleic acid. In still other embodiments, suitable soybeans used to produce the compositions herein are as described in Table 1.

TABLE 1
VARIETY DESCRIPTION INFORMATION

Hypocotyl color: Bronze
Seed Coat Color (Mature Seed): Clear
Seed Coat Luster (Mature Hand Shelled Seed): Dull
Seed Color (Mature Seed): Yellow
Leaflet Shape: Ovate
Growth Habit: Indeterminate
Flower Color: Purple
Hilum Color (Mature Seed): Yellow
Plant Pubescence Color: Grey
Pod Wall Color: Brown
Maturity Group: 1
Relative Maturity: 1.2
Plant Lodging Score: 1.7
Plant Height (cm): 63
Percent Protein: 43.2% dry weight
Percent Oil: 21.9% dry weight

In some embodiments, suitable soybeans used to produce the compositions herein include those described in U.S. Pat. No. 11,191,239, which is hereby incorporated herein by reference with respect to columns 5-6 on page 4, and columns 41-42 on page 22. In some embodiments, suitable soybeans used to produce the compositions herein are obtained from a plant or seed of soybean cultivar 2851015, wherein a representative sample of seed of said cultivar is deposited under NCMA No. 202104025. Soybean cultivar 2851015 is a late-group III maturity variety. Additionally, soybean cultivar 2851015 is resistant to Soybean Cyst Nematode Race 3 and tolerant to sulfonylurea herbicides. In some embodiments, soybean cultivar 2851015 is characterized by its oil and/or carbohydrate profile. In some embodiments, soybean cultivar 2851015 is characterized as having one or more of the following: high oleic acid content, 79.3%, low linolenic acid content about 2.0%, 8.1% palmitic acid, 3.7% stearic acid, and 6.9% linoleic acid, where the percentages are measured as a percentage of the total fats (unsaturated and saturated fats). In other embodiments, soybean cultivar 2851015 is characterized as having one or more of the following: low raffinose 0.050% and stachyose 0.390% content. In some embodiments, the soybeans have a stachyose content of less than about 1% on a dry weight basis, a raffinose content of less than about 0.5% on a dry weight basis, and at least about 70% by weight of the total fatty acid in the soybean is oleic acid. In some embodiments, the soybeans have a protein content of at least about 43% on a dry weight basis, a stachyose content of less than about 1% on a dry weight basis, a raffinose content of less than about 0.5% on a dry weight basis, and at least about 70% by weight of the total fatty acid in the soybean is oleic acid. In some embodiments, the soybeans have a protein content of at least about 43% on a dry weight basis, a stachyose content of less than about 1% on a dry weight basis, a raffinose content of less than about 0.5% on a dry weight basis, no more than about 250 mg/kg total glycitein compounds on a dry weight basis, and at least about 70% by weight of the total fatty acid in the soybean is oleic acid. In still other embodiments, suitable soybeans used to produce the compositions herein are as described in Table 2.

TABLE 2
VARIETY DESCRIPTION INFORMATION

Hypocotyl Color: Purple
Seed Coat Color (Mature Seed): Clear
Seed Coat Luster (Mature Hand Shelled Seed): Dull
Seed Color (Mature Seed): Yellow
Leaflet Shape: Ovate
Growth Habit: Indeterminate
Flower Color: Purple
Hilum Color (Mature Seed): Black
Plant Pubescence Color: Tawny
Pod Wall Color: Brown
Maturity Group: 3
Relative Maturity: 3.8
Plant Lodging Score: 3
Plant Height (cm): 104
Percent Protein: 42.7
Percent Oil: 22.1

In some embodiments, suitable soybeans used to produce the compositions herein include those described in U.S. Pat. No. 8,563,826, which is hereby incorporated herein by reference with respect to columns 5-6 on page 4, and column 36 on page 19. In some embodiments, suitable soybeans used to produce the compositions herein are obtained from a plant or seed of soybean cultivar 5555821658, wherein a representative sample of seed of said cultivar is deposited under NCIMB No. 42115. Soybean cultivar 5555821658 is a late-group III maturity variety. Additionally, soybean cultivar 5555821658 is resistant to Soybean Cyst Nematode Race 3, and sulfonylurea herbicides. In some embodiments, the soybeans have a protein content of at least about 44% protein on a dry weight basis. In some embodiments, the soybeans have a protein content of at least about 44% protein on a dry weight basis, a stachyose content of less than about 4% on a dry weight basis, and a raffinose content of less than about 1% on a dry weight basis. In some embodiments, the soybeans have a protein content of at least about 44% protein on a dry weight basis, a stachyose content of less than about 4% on a dry weight basis, a raffinose content of less than about 1% on a dry weight basis, and no more than about 275 mg/kg total glycitein compounds on a dry weight basis. In still other embodiments, suitable soybeans used to produce the compositions herein are as described in Table 3.

TABLE 3
VARIETY DESCRIPTION INFORMATION

Seed Coat Color (Mature Seed): Clear
Seed Coat Luster (Mature Hand Shelled Seed): Dull
Seed Color (Mature Seed): Yellow
Leaflet Shape: Ovate
Growth Habit: Indeterminate
Flower Color: Purple
Hilum Color (Mature Seed): Black
Plant Pubescence Color: Tawny
Pod Wall Color: Brown
Maturity Group: 3
Relative Maturity: 3.7
Lodging Resistance: 19
Plant Height (cm): 79
Percent Protein: 42.1
Percent Oil: 21.0

In some embodiments, suitable soybeans used to produce the compositions herein include those described in U.S. Pat. No. 9,992,965, which is hereby incorporated herein by reference with respect to columns 5-6 on page 4, and column 37 on page 20. In some embodiments, suitable soybeans used to produce the compositions herein are obtained from a plant or seed of soybean cultivar 218023621658, wherein a representative sample of seed of said cultivar is deposited under NCMA No. 42979. Soybean cultivar 218023621658 is an early group II maturity variety. Additionally, soybean cultivar 218023621658 is resistant to Soybean Cyst Nematode Race 3. In some embodiments, the soybeans have at least about 44% protein on a dry weight basis, a stachyose content of less than about 1% on a dry weight basis, and a raffinose content of less than about 0.5% on a dry weight. In some embodiments, the soybeans have at least about 45% protein on a dry weight basis, a stachyose content of less than about 1% on a dry weight basis, and a raffinose content of less than about 0.5% on a dry weight. In some embodiments, the soybeans have at least about 45% protein on a dry weight basis, a stachyose content of less than about 1% on a dry weight basis, a raffinose content of less than about 0.5% on a dry weight, and about 225 mg/kg total glycitein compounds on a dry weight basis. In still other embodiments, suitable soybeans used to produce the compositions herein are as described in Table 4.

TABLE 4
VARIETY DESCRIPTION INFORMATION

Hypocotyl Color: Green
Seed Coat Color (Mature Seed): Clear
Seed Coat Luster (Mature Hand Shelled Seed): Dull
Seed Color (Mature Seed): Yellow
Leaflet Shape: Ovate
Growth Habit: Indeterminate
Flower Color: White
Hilum Color (Mature Seed): Brown
Plant Pubescence Color: Tawny
Pod Wall Color: Brown
Maturity Group: 2
Relative Maturity: 2.3
Plant Lodging Score: 2.5
Plant Height (cm): 89
Percent Protein: 45.1% dry weight
Percent Oil: 19.3%
Raffinose seed content: <0.111% (w/w) seed content
Stachyose seed content: 0.369% (w/w) seed content

In some embodiments, suitable soybeans used to produce the compositions herein include those described in U.S. Pat. No. 11,206,796, which is hereby incorporated herein by reference with respect to columns 5-6 on page 4, and columns 41-42 on page 22. In some embodiments, suitable soybeans used to produce the compositions herein are obtained from a plant or seed of soybean cultivar 1967799, wherein a representative sample of seed of said cultivar is deposited under NCMA No. 202109074. Soybean cultivar 1967799 is an early-group IV maturity variety. Additionally, soybean cultivar 1967799 is resistant to Soybean Cyst Nematode Race 3, and is resistant to Phytophthora root rot. In some embodiments, the soybeans have at least 48% protein on a dry weight basis. In some embodiments, the soybeans have at least 48% protein on a dry weight basis, a stachyose content of less than about 4.5% on a dry weight basis, and a raffinose content of less than about 1% on a dry weight. In some embodiments, the soybeans have at least 48% protein on a dry weight basis, a stachyose content of less than about 4.5% on a dry weight basis, a raffinose content of less than about 1% on a dry weight, and about 325 mg/kg total glycitein compounds on a dry weight basis. In still other embodiments, suitable soybeans used to produce the compositions herein are as described in Table 5.

TABLE 5
VARIETY DESCRIPTION INFORMATION

Hypocotyl Color: White
Seed Coat Color (Mature Seed): Clear
Seed Coat Luster (Mature Hand Shelled Seed): Dull
Seed Color (Mature Seed): Yellow
Leaflet Shape: Ovate
Growth Habit: Indeterminate
Flower Color: White
Hilum Color (Mature Seed): Black
Plant Pubescence Color: Tawny
Pod Wall Color: Brown
Maturity Group: 4
Relative Maturity: 4.2
Plant Lodging Score: 1.9
Plant Height (cm): 98
Percent Protein: 47.1
Percent Oil: 18.3

The present invention is not limited to whether the soybeans comprise transgenic polynucleotides or proteins. The soybeans used in the Examples herein are non-transgenic and there are circumstances when using soybeans lacking transgenic traits, genome edits, or any other form of mutation (e.g., a change in a polynucleotide sequence) is necessary and/or beneficial. However, combining the teachings herein with a wide range of transgenic plants, or plants containing genome edits or any other form of mutation to confer new traits or combinations thereof is also envisioned.

As used herein, a “mutation” is any change in a nucleic acid sequence. Examples may include insertions, deletions, duplications, substitutions, inversions, and translocations of any nucleic acid sequence, regardless of how the mutation is brought about and regardless of how or whether the mutation alters the functions or interactions of the nucleic acid. For example and without limitation, a mutation may produce altered enzymatic activity of a ribozyme, altered base pairing between nucleic acids (e.g. RNA interference interactions, DNA-RNA binding, etc.), altered mRNA folding stability, and/or how a nucleic acid interacts with polypeptides (e.g. DNA-transcription factor interactions, RNA-ribosome interactions, gRNA-endonuclease reactions, etc.). A mutation might result in the production of proteins with altered amino acid sequences (e.g. missense mutations, nonsense mutations, frameshift mutations, etc.) and/or the production of proteins with the same amino acid sequence (e.g. silent mutations). Certain synonymous mutations may create no observed change in the plant while others that encode for an identical protein sequence nevertheless result in an altered plant phenotype (e.g. due to codon usage bias, altered secondary protein structures, etc.). Mutations may occur within coding regions (e.g., open reading frames) or outside of coding regions (e.g., within promoters, terminators, untranslated elements, or enhancers), and may affect, for example and without limitation, gene expression levels, gene expression profiles, protein sequences, and/or sequences encoding RNA elements such as tRNAs, ribozymes, ribosome components, and microRNAs.

In certain embodiments, soybeans as disclosed herein may be obtained from soybean plants modified to exhibit at least one desired trait, and/or combinations thereof. The disclosed innovations are not limited to any set of traits that can be considered desirable, but nonlimiting examples include male sterility, herbicide tolerance, pest tolerance, disease tolerance, modified fatty acid metabolism, modified carbohydrate metabolism, modified seed yield, modified seed oil, modified seed protein, modified lodging resistance, modified shattering, modified iron-deficiency chlorosis, modified water use efficiency, and/or combinations thereof.

In certain embodiments, a user can combine the teachings herein with high-density molecular marker profiles spanning substantially the entire soybean genome to estimate the value of selecting certain candidates in a breeding program in a process commonly known as genomic selection.

In some embodiments of the present disclosure, the soybeans having high protein content as utilized herein may be characterized by any suitable methods known in the art for genetic analysis. In some embodiments, the soybeans as utilized herein may be characterized by genetic analysis as comprising one or more genetic markers associated with high protein content and one or more genetic markers associated with additional favorable characteristics, including, for example, low indigestible oligosaccharide content, low raffinose content, low stachyose content, high oleic acid content, low total glycitein compounds content. In some embodiments, the soybeans as utilized herein may be characterized by genetic analysis as comprising one or more genetic markers associated with high protein content and/or one or more genetic markers associated with low raffinose content and/or one or more genetic markers associated with low stachyose content as described above. In some embodiments, the soybeans as utilized herein may be characterized by genetic analysis as comprising one or more genetic markers associated with high protein content.

### II. Methods of Producing Soy Milk Compositions

The present disclosure provides methods of producing soy milk compositions having a high protein content. In one aspect, provided herein is a method for producing a soy milk composition, comprising providing soybeans having a high protein content and processing the soybeans to produce a soy milk composition having a high protein content.

In one aspect, provided herein is a method for producing a soy milk composition, comprising a) providing soybeans; b) drying, and optionally cracking, the soybeans to provide dried soybeans; c) dehulling the dried soybeans to provide soy grits; d) grinding the soy grits in hot water to provide a soy slurry; e) heating the soy slurry; f) cooling the soy slurry; and g) filtering the soy slurry, thereby providing the soy milk composition.

In another aspect, provided herein is a method for producing a soy milk composition comprising at least about 4 g of soy protein per 100 mL of liquid volume. In some variations, provided herein is a method for producing a soy milk composition comprising between about 4 g and about 10 g of soy protein per 100 mL of liquid volume.

In one aspect, provided herein is a method for producing a soy milk composition, comprising a) providing soybeans, wherein the soy beans comprise at least about 40% soy protein on a dry weight basis; b) drying, and optionally cracking, the soybeans to provide dried soybeans; c) dehulling the dried soybeans to provide soy grits; d) grinding the soy grits in hot water to provide a soy slurry; e) heating the soy slurry; f) cooling the soy slurry; and g) filtering the soy slurry, thereby providing the soy milk composition, wherein the soy milk composition comprises at least about 4 g of soy protein per 100 mL of liquid volume.

In yet another aspect, provided herein is a method for producing a soy milk composition comprising at least about 0.4 g of soy protein per 1 g of soy solids.

In still another aspect, provided herein is a method for producing a soy milk composition, comprising a) providing soybeans, wherein the soy beans comprise at least about 40% soy protein on a dry weight basis; b) drying, and optionally cracking, the soybeans to provide dried soybeans; c) dehulling the dried soybeans to provide soy grits; d) grinding the soy grits in hot water to provide a soy slurry; e) heating the soy slurry; f) cooling the soy slurry; and g) filtering the soy slurry, thereby providing the soy milk composition, wherein the soy milk composition comprises at least about 0.4 g of soy protein per 1 g of soy solids.

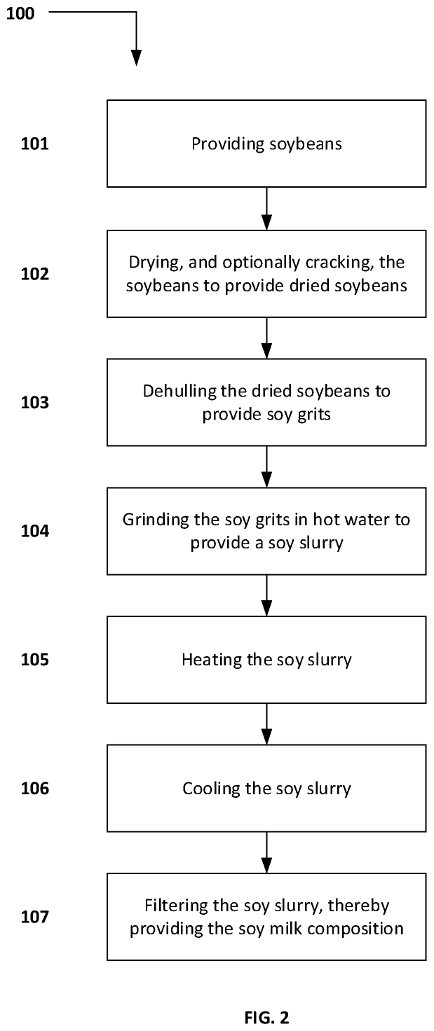

With reference to FIG. 2, process 100 is an exemplary process to prepare a soy milk composition having a high protein content. In step 101, soybeans having a high protein content are provided. In some variations of any of the foregoing aspects, the soybeans having a high protein content comprise at least about 40%, at least about 41%, at least about 42%, at least about 43%, at least about 44%, at least about 45%, at least about 46%, at least about 47%, at least about 48%, at least about 49%, at least about 50%, at least about 51%, or at least about 52% soy protein on a dry weight basis. In certain variations, the soybeans comprise at least about 42% soy protein on a dry weight basis. In some variations, the soybeans comprise at least about 45% soy protein on a dry weight basis. In other variations, the soybeans comprise at least about 48% soy protein on a dry weight basis.

In some embodiments, step 101 further comprises cleaning the soybeans. In some embodiments, step 101 further comprises tempering the soybeans. Any suitable methods of tempering soybeans known in the art may be employed.

With reference again to FIG. 2, in step 102, the soybeans are dried to provide dried soybeans. In certain embodiments, the dried soybeans may be characterized by their moisture content. In some variations, the treated soybeans obtained from the thermal treatment have a moisture content of less than or equal to about 20% w/w, less than or equal to about 17% w/w, less than or equal to about 15% w/w, less than or equal to about 12% w/w, less than or equal to about 10% w/w, or less than or equal to about 8% w/w, without further drying. In certain embodiments, the dried soybeans have a moisture content of less than or equal to about 10% w/w. In other variations, the dried soybeans have a moisture content of between about 5% w/w and about 20% w/w, between about 5% w/w and about 17% w/w, between about 5% w/w and about 15% w/w, between about 5% w/w and about 12% w/w, between about 5% w/w and about 10% w/w, between about 5% w/w and about 8% w/w, between about 8% w/w and about 20% w/w, between about 8% w/w and about 17% w/w, between about 8% w/w and about 15% w/w, between about 8% w/w and about 12% w/w, between about 8% w/w and about 10% w/w, between about 10% w/w and about 20% w/w, between 10% w/w and about 17% w/w, between about 10% w/w and about 15% w/w, between about 10% w/w and about 12% w/w, between about 12% w/w and about 20% w/w, between about 12% w/w and about 17% w/w, between about 12% w/w and about 15% w/w, between about 15% w/w and about 20% w/w, between about 15% w/w and about 17% w/w, or between about 17% w/w and about 20% w/w, without further drying. In yet other variations, the dried soybeans may be dried in order to control the moisture content prior to further processing.

In other embodiments, in step 102, the method may comprise cracking the soybeans. In some embodiments, the step of cracking the soybeans is performed with cracking rolls or impact crushers. Cracking the dried beans prior to dehulling may improve the efficiency of the hull removal.

In some embodiments, step 103 further comprises dehulling the dried soybeans to provide soy grits. In certain embodiments wherein the dried soybeans have been cracked, step 103 may comprise dehulling the dried, cracked soybeans to provide soy grits. Any suitable techniques known in the art to remove the hulls from the soybeans may be employed. For example, in some variations, the soybeans are subjected to abrasive force in order to remove the hulls. In certain variations, dehulling may be carried out with an attrition mill or an impeller, or mechanical equivalent. In one variation, the dehulling step does not utilize wet removal methods, such as blanching, alkaline and/or aqueous dissolution. In certain embodiments, the soybeans undergo thermal treatment prior to hull removal. In some variations, such thermal treatment is a dry dehulling process, which is distinguished from a wet dehulling process that may involve, for example, blanching.

In some variations, removing the hulls from the dried soybeans results in a mixture comprising dehulled soybeans and detached hulls. As such, the method may further comprise separating the detached hulls from the dehulled soybeans to provide isolated soy grits. In some embodiments, the method further comprises separating the dehulled soybeans from the detached hulls by hand separation, by sieving or screening, or aerodynamic separation (i.e., weight classification by aspiration).

Again, with reference to FIG. 2, in step 104, the method may comprise grinding the soy grits in hot water to provide a soy slurry. In some embodiments, the water is preheated prior to being combined with the soy grits. In some embodiments, the water is preheated to a temperature of at least about 30° C., at least about 40° C., at least about 50° C., at least about 60° C., at least about 70° C., at least about 80° C., at least about 90° C., or about at least 100° C. In some embodiments, the water is preheated to a temperature of at least about 80° C. In some embodiments, the temperature of the hot water combined with the soy grits is at least about 30° C., at least about 40° C., at least about 50° C., at least about 60° C., at least about 70° C., at least about 80° C., at least about 90° C., or about at least 100° C. In some embodiments, the temperature of the hot water combined with the soy grits is at least about 80° C. In some embodiments, the method comprises mixing, agitating, or stirring the soy grits and hot water prior to grinding the soy grits and hot water.

In some embodiments, the volume of hot water added to a given quantity of soy grits may be adjusted to achieve a certain nutritional profile of the final soy milk composition, e.g., grams of protein per serving or grams of protein per 100 mL of liquid volume. It should be recognized that larger volumes of water combined with a certain quantity of soy grits may result in reduced amounts of nutritional components, e.g., protein, total lipids, total sugars, total carbohydrates, per serving.

Additionally, in some variations, the amount of hot water added to a given quantity of soy grits may impact the textural profile of the resulting soy milk composition. For example, the use of too low a ratio of hot water to soy grits may result in a soy milk composition that is perceived as “too thick”, a property which may be undesirable to consumers. Likewise, for soy milk compositions where a high protein content is targeted, the use of soybeans with too low of a germplasm protein content may require a low water-to-soy grits ratio to achieve the desired soy milk protein content, thus leading to a soy milk that is perceived as “too thick”. Accordingly, the use of high protein soybeans may be advantageous for preparing high protein soy milk compositions with desirable textural properties.

In some embodiments, the ratio of hot water to soy grits may be adjusted in the grinding step. In some embodiments, the weight ratio of water-to-soy grits is at least about 4:1, at least about 5:1, at least about 6:1, at least about 7:1, at least about 8:1, at least about 9:1, at least about 10:1, at least about 11:1, or at least about 12:1. In other embodiments, the weight ratio of water-to-soy grits is less than or equal to about 15:1, less than or equal to about 14:1, less than or equal to about 13:1, less than or equal to about 12:1, less than or equal to about 11:1, less than or equal to about 10:1, less than or equal to about 9:1 or less than or equal to about 8:1. In some embodiments, the weight ratio of water-to-soy grits is between about 4:1 and about 15:1, between about 5:1 and about 15:1, between about 5:1 and about 10:1, between about 5:1 and about 9:1, between about 5:1 and about 8:1, between about 6:1 and about 9:1, or between about 6:1 and about 8:1. In certain embodiments, the weight ratio of water-to-soy grits is between about 5:1 and about 10:1.

Grinding can be performed using any suitable techniques known in the art. For example, grinding can be performed using equipment such as a hammer mill, FitzMill or Quadromill. In some embodiments, the method comprises grinding the soy grits in hot water to provide a soy slurry having a certain particle size distribution.

In some embodiments, step 105 further comprises heating the soy slurry. In some embodiments, the soy slurry is heated to a temperature of at least about 30° C., at least about 40° C., at least about 50° C., at least about 60° C., at least about 70° C., at least about 80° C., at least about 90° C., or at least about 100° C. In some embodiments, the soy slurry is heated to a temperature of less than or equal to 200° C., less than or equal to 180° C., less than or equal to 160° C., less than or equal to 150° C., less than or equal to 140° C., less than or equal to 120° C., less than or equal to 100° C., or less than or equal to 80° C. In some embodiments, the soy slurry is heated to at least about 80° C. In some embodiments, the soy slurry is mixed, agitated, or stirred while it is heated. In some embodiments step 105 comprises holding the soy slurry at a single temperature or within a temperature range for a period of time. In some embodiments, the soy slurry is held at a temperature of at least about 20° C., at least about 30° C., at least about 40° C., at least about 50° C., at least about 60° C., at least about 70° C., at least about 80° C., at least about 90° C., or at least about 100° C. In other embodiments, the soy slurry is held at a temperature of less than or equal to 200° C., less than or equal to 180° C., less than or equal to 160° C., less than or equal to 150° C., less than or equal to 140° C., less than or equal to 120° C., less than or equal to 100° C., or less than or equal to 80° C. In some embodiments, the soy slurry is held at a temperature of about 80° C. In some embodiments, the soy slurry is held at any of the aforementioned temperatures for about 30 seconds, about 1 minute, about 2 minutes, about 5 minutes, about 10 minutes, about 15 minutes, about 20 minutes, about 25 minutes, about 30 minutes, about 1 hour, about 2 hours, about 3 hours, about 6 hours, about 12 hours, or about 24 hours.

In some embodiments, with reference to FIG. 2, step 106, the method further comprises cooling the soy slurry. In some embodiments, the soy slurry is cooled to room temperature. In some embodiments, the soy slurry is cooled to a temperature of between about 20° C. and about 25° C.

With reference to FIG. 2 again, in step 107, the method comprises filtering the soy slurry to provide a soy milk composition having high protein content. Filtering may be performed using any suitable techniques known in the art. Filtration may remove unwanted solid particles larger than a threshold size, to provide a soy milk composition as the filtered permeate. The resulting filtered soy milk composition contains particles smaller than the desired threshold size. Filtration of the soy slurry may improve the overall texture and palatability (e.g., grittiness) of the resulting soy milk composition. In some embodiments, the method comprises filtering the soy slurry with a mesh or sieve. In certain embodiments, the method comprises filtering the soy slurry to remove solid particles greater than or equal to about 100 μm, greater than or equal to about 90 μm, greater than or equal to about 75 μm, greater than or equal to about 60 μm, greater than or equal to about 50 μm, greater than or equal to about 40 μm, greater than or equal to about 30 μm, greater than or equal to about 25 μm or greater than or equal to about 20 μm. In some embodiments, the soy milk composition may be characterized by the particle size characteristics of any particles remaining in the soy milk composition after filtering. For example, in some embodiments, the soy milk composition does not contain particles greater than or equal to about 100 μm, greater than or equal to about 90 μm, greater than or equal to about 75 μm, greater than or equal to about 60 μm, greater than or equal to about 50 μm, greater than or equal to about 40 μm, greater than or equal to about 30 μm, greater than or equal to about 25 μm or greater than or equal to about 20 μm.

As detailed above, the methods provided herein, utilizing soybeans having high protein content, may result in soy milk compositions having high protein content relative to the soy solids (per gram) present in the soy milk composition or with respect to given liquid volume (e.g., per 100 mL) or serving size (e.g., per 8 fl. oz.) of the soy milk composition. In some embodiments, the soy milk composition comprises at least about 0.4 g, at least about 0.41 g, at least about 0.42 g, at least about 0.43 g, at least about 0.44 g, at least about 0.45 g, at least about 0.46 g, at least about 0.47 g, at least about 0.48 g, at least about 0.49 g, at least about 0.5 g, at least about 0.51 g, or at least about 0.52 g of soy protein per 1 g of soy solids. In certain embodiments, the soy milk composition comprises at least about 0.4 g, at least about 0.42 g, at least about 0.44 g, at least about 0.48 g, or at least about 0.5 g of soy protein per 1 g of soy solids. In certain embodiments, the soy milk composition comprises at least about 0.4 g of soy protein per 1 g of soy solids. In certain other embodiments, the soy milk composition comprises at least about 0.42 g of soy protein per 1 g of soy solids. In still other embodiments, the soy milk composition comprises at least about 0.44 g of soy protein per 1 g of soy solids. In yet certain other embodiments, the soy milk composition comprises at least about 0.48 g of soy protein per 1 g of soy solids. In still other embodiments, the soy milk composition comprises at least about 0.5 g of soy protein per 1 g of soy solids. In some embodiments, the soy milk composition comprises between about 0.4 g and about 0.8 g of soy protein per 1 g of soy solids.

In other embodiments, the soy milk composition comprises at least about 4 g, at least about 4.1 g, at least about 4.2 g, at least about 4.3 g, at least about 4.4 g, at least about 4.5 g, at least about 4.6 g, at least about 4.7 g, at least about 4.8 g, at least about 4.9 g, at least about 5 g, at least about 5.1 g or at least about 5.2 g of soy protein per 100 mL of liquid volume of soy milk composition. In some embodiments, the soy milk composition comprises at least about 4 g, at least about 4.2 g, at least bout 4.4 g, at least about 4.8 g or at least about 5 g of soy protein per 100 mL of liquid volume. In certain embodiments, the soy milk composition comprises at least about 4 g of soy protein per 100 mL of liquid volume. In certain other embodiments, the soy milk composition comprises at least about 4.2 g of soy protein per 100 mL of liquid volume. In still other embodiments, the soy milk composition comprises at least bout 4.4 g of soy protein per 100 mL of liquid volume. In yet certain other embodiments, the soy milk composition comprises at least about 4.8 g of soy protein per 100 mL of liquid volume. In still other embodiments, the soy milk composition comprises at least about 5 g of soy protein per 100 mL of liquid volume. In some embodiments, the soy milk composition comprises between about 4 g and about 10 g of soy protein per 100 mL of liquid volume.

In some embodiments, the soy milk compositions as produced by the methods described in the present section may be further characterized by the content of certain nutritional components and/or sensory characteristics as detailed in Section B below.

It should be noted that the foregoing methods may include variations of other parameters that may be part of the steps described herein including, for example, drying temperature and/or time, the rate of mixing, particle size distribution of the soy grits after dehulling and/or cracking, grinding time, grinding temperature and/or feed rates into the grinding apparatus, and particle size distribution of the particles in the soy slurry.

It should be understood that, in other variations, process 100 may include additional processing steps. In yet other variations, certain steps in process 100 may be omitted.

### III. Methods of Producing Soy Yogurt Compositions

The present disclosure also provides methods of producing soy yogurt compositions having a high protein content. In one aspect, provided herein is a method for producing a soy yogurt composition, comprising providing soybeans having a high protein content and processing the soybeans to produce a soy milk composition having a high protein content, and further processing the soy milk composition having a high protein content to produce a soy yogurt composition having a high protein content. In yet another aspect, provided herein is a method of producing a soy yogurt composition comprising providing a soy milk composition having a high protein content, and processing the soy milk composition having a high protein content to produce a soy yogurt composition. In some embodiments, the soy milk composition comprises at least about 0.4 g of soy protein per g soy solids or at least about 4 g of soy protein per 100 mL of liquid volume. In some embodiments, the soy milk composition may be produced according to the methods as described herein.

In one aspect, provided herein is a method for producing a soy yogurt composition comprising a) providing a soy milk composition; b) heating the soy milk composition to provide a heated soy milk composition; c) cooling the heated soy milk composition to an incubation temperature; d) adding a bacterial starter culture, and optionally a coagulant, to the heated soy milk composition to provide a soy culture mixture; e) incubating the soy culture mixture at an incubation temperature to provide a fermented soy composition; and straining the fermented soy composition to provide the soy yogurt composition.

In yet another aspect, provided herein is a method for producing a soy yogurt composition, comprising a) providing a soy milk composition comprising at least about 0.4 g of soy protein per g of soy solids; b) heating the soy milk composition to provide a heated soy milk composition; c) cooling the heated soy milk composition to an incubation temperature; d) adding a bacterial starter culture, and optionally a coagulant, to the heated soy milk composition to provide a soy culture mixture; e) incubating the soy culture mixture at an incubation temperature to provide a fermented soy composition; and straining the fermented soy composition to provide the soy yogurt composition.

In still yet another aspect, provided herein is a method for producing a soy yogurt composition, comprising a) providing a soy milk composition comprising at least about 4 g of soy protein per 100 mL of liquid volume of the soy milk composition; b) heating the soy milk composition to provide a heated soy milk composition; c) cooling the heated soy milk composition to an incubation temperature; d) adding a bacterial starter culture, and optionally a coagulant, to the heated soy milk composition to provide a soy culture mixture; e) incubating the soy culture mixture at an incubation temperature to provide a fermented soy composition; and straining the fermented soy composition to provide the soy yogurt composition.

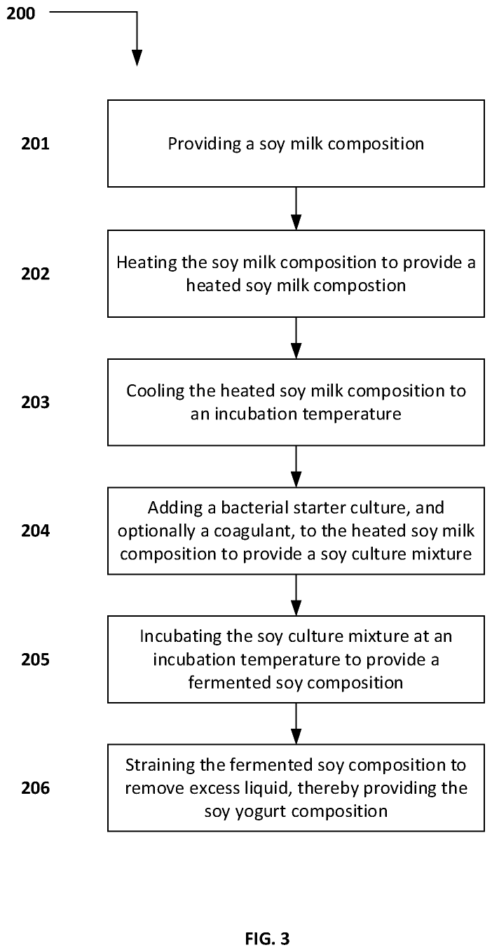

With reference to FIG. 3, process 200 is an exemplary process to prepare a soy yogurt composition having high protein content according to the present disclosure. In step 201, a soy milk composition having a high protein content is provided. In some embodiments, the soy milk composition comprises at least about 0.4 g, at least about 0.41 g, at least about 0.42 g, at least about 0.43 g, at least about 0.44 g, at least about 0.45 g, at least about 0.46 g, at least about 0.47 g, at least about 0.48 g, at least about 0.49 g, at least about 0.5 g, at least about 0.51 g, or at least about 0.52 g of soy protein per 1 g of soy solids. In certain embodiments, the soy milk composition comprises at least about 0.4 g, at least about 0.42 g, at least about 0.44 g, at least about 0.48 g, or at least about 0.5 g of soy protein per 1 g of soy solids. In certain embodiments, the soy milk composition comprises at least about 0.4 g of soy protein per 1 g of soy solids. In certain other embodiments, the soy milk composition comprises at least about 0.42 g of soy protein per 1 g of soy solids. In still other embodiments, the soy milk composition comprises at least about 0.44 g of soy protein per 1 g of soy solids. In yet certain other embodiments, the soy milk composition comprises at least about 0.48 g of soy protein per 1 g of soy solids. In still other embodiments, the soy milk composition comprises at least about 0.5 g of soy protein per 1 g of soy solids. In some embodiments, the soy milk composition comprises between about 0.4 g and about 0.8 g of soy protein per 1 g of soy solids.

In other embodiments, the soy milk composition comprises at least about 4 g, at least about 4.1 g, at least about 4.2 g, at least about 4.3 g, at least about 4.4 g, at least about 4.5 g, at least about 4.6 g, at least about 4.7 g, at least about 4.8 g, at least about 4.9 g, at least about 5 g, at least about 5.1 g or at least about 5.2 g of soy protein per 100 mL of liquid volume of soy milk composition. In some embodiments, the soy milk composition comprises at least about 4 g, at least about 4.2 g, at least bout 4.4 g, at least about 4.8 g or at least about 5 g of soy protein per 100 mL of liquid volume. In certain embodiments, the soy milk composition comprises at least about 4 g of soy protein per 100 mL of liquid volume. In certain other embodiments, the soy milk composition comprises at least about 4.2 g of soy protein per 100 mL of liquid volume. In still other embodiments, the soy milk composition comprises at least bout 4.4 g of soy protein per 100 mL of liquid volume. In yet certain other embodiments, the soy milk composition comprises at least about 4.8 g of soy protein per 100 mL of liquid volume. In still other embodiments, the soy milk composition comprises at least about 5 g of soy protein per 100 mL of liquid volume. In some embodiments, the soy milk composition comprises between about 4 g and about 10 g of soy protein per 100 mL of liquid volume.

In some embodiments, the soy milk composition is produced from soybeans having a high protein content as described herein. In some embodiments, the soy milk composition may be produced according to the methods as described herein. In some embodiments, the soy milk compositions as produced by the methods described in the present section may be further characterized by the content of certain nutritional components and/or sensory characteristics as detailed in Section B below.

With reference again to FIG. 3, in step 202, the soy milk composition is heated to provide a heated soy milk composition. The heating of the soy milk composition may serve one or more functions including, for example, pasteurization, protein denaturation and/or deactivation of undesirable enzymes, and removal of volatile, unsavory flavor compounds. Pasteurization is a standard food processing technique, in which products for consumption by humans are treated with mild heat, usually to less than 100° C. (212° F.), to eliminate pathogens and extend shelf life.

In some embodiments, the soy milk composition is heated to a certain temperature. In some embodiments, the soy milk composition is heated to a temperature of at least about 50° C., at least about 60° C., at least about 70° C., or at least about 80° C. In other embodiments, the soy milk composition is heated to a temperature of less than or equal to 100° C., less than or equal to 90° C., or less than or equal to 80° C. In some embodiments, the soy milk composition is heated to a temperature of between about 50° C. and about 100° C., between about 60° C. and about 90° C., between about 70° C. and about 80° C., or between about 70° C. and about 90° C. In certain embodiments, the soy milk composition is heated to a temperature of between about 70° C. and about 90° C.

In some embodiments, the soy milk composition is heated to a given temperature and maintained at the temperature for a specified period of time in order to achieve the desired pasteurization and/or protein denaturation. In some embodiments, the heated soy milk composition is held at any of the aforementioned temperatures for about 30 seconds, about 1 minute, about 2 minutes, about 5 minutes, about 10 minutes, about 15 minutes, about 20 minutes, about 25 minutes, or about 30 minutes. It should be recognized that the period of time that the heated soy milk composition is maintained at a given temperature may depend upon the temperature. For example, lower temperatures may be maintained for longer periods of time than higher temperatures.

With reference to FIG. 3, in step 203, the heated soy milk composition is cooled to a lower temperature. In some embodiments, the lower temperature is an incubation temperature suitable for supporting fermentation. The lowering of the temperature of the heated soy milk composition allows for the addition of bacterial starter culture, as temperatures above a certain threshold may kill or inactive the bacterial starter culture. In some embodiments, the heated soy milk composition is cooled to a temperature of less than or equal to about 50° C., less than or equal to about 47° C., less than or equal to about 46° C., less than or equal to about 45° C., less than or equal to about 44° C., less than or equal to about 43° C., less than or equal to about 42° C., less than or equal to about 41° C., less than or equal to about 40° C., less than or equal to about 35° C., or less than or equal to about 30° C. In other embodiments, the heated soy milk composition is cooled to a temperature of greater than or equal about 20° C., greater than or equal about 22° C., greater than or equal about 25° C., greater than or equal about 30° C., greater than or equal about 35° C., or greater than or equal about 40° C. In some embodiments, the heated soy milk is cooled to a temperature of between about 20° C. and about 50° C., between about 30° C. and about 50° C., between about 40° C. and about 50° C., between about 20° C. and about 40° C., between about 30° C. and about 40° C., between about 41° C. and about 47° C. In some embodiments, the heated soy milk is cooled to a temperature of between about 40° C. and about 50° C.

Following the lowering of the temperature of the heated soy milk composition in step 203, a bacterial starter culture is added to the heated soy milk composition in step 204 to provide a soy culture mixture. The bacterial starter culture is added to the heated soy milk composition to initiate fermentation. In some embodiments, the bacterial starter culture comprises one or more bacterial strains. In certain embodiments, the bacterial starter culture comprises Lactobacillus spp., Streptococcus spp., and/or Bifidobacterium spp. In certain other embodiments, the bacterial culture starter comprises Lactobacillus delbrueckii and Streptococcus thermophilus.

In further variations of step 204, the method may further comprise adding a coagulant to promote thickening of the soy culture mixture. In some embodiments, the method comprises adding animal-derived or plant-derived rennet.

With reference to FIG. 3, in step 205, the soy culture mixture is incubated at a suitable temperature and time to allow for fermentation by the bacterial starter culture. In some embodiments, the temperature at which and the time period during which the soy culture mixture is incubated may be referred to as the incubation temperature and incubation time, respectively.

In some embodiments, the incubation temperature is the same temperature as the temperature to which the heated soy milk composition was cooled. In some embodiments, the In some embodiments, the incubation temperature is less than or equal to about 50° C., less than or equal to about 47° C., less than or equal to about 46° C., less than or equal to about 45° C., less than or equal to about 44° C., less than or equal to about 43° C., less than or equal to about 42° C., less than or equal to about 41° C., less than or equal to about 40° C., less than or equal to about 35° C., or less than or equal to about 30° C. In other embodiments, the incubation temperature is greater than or equal about 20° C., greater than or equal about 22° C., greater than or equal about 25° C., greater than or equal about 30° C., greater than or equal about 35° C., or greater than or equal about 40° C. In still other embodiments, the incubation temperature is between about 20° C. and about 50° C., between about 30° C. and about 50° C., between about 40° C. and about 50° C., between about 20° C. and about 40° C., between about 30° C. and about 40° C., between about 41° C. and about 47° C. In some embodiments, the incubation temperature is between about 40° C. and about 50° C. In some embodiments the incubation time is at least about 3 hours, at least about 4 hours, at least about 5 hours, at least about 6 hours, at least about 7 hours, at least about 8 hours, at least about 9 hours, at least about 10 hours, at least about 11 hours, or at least about 12 hours. In other embodiments, the incubation time is less than or equal to about 24 hours, less than or equal to about 20 hours, less than or equal to about 18 hours, less than or equal to about 16 hours, less than or equal to about 14 hours, less than or equal to about 12 hours, or less than or equal to about 10 hours. In certain embodiments, the incubation time is between about 3 hours and 12 hours, between about 4 hours and 10 hours, or between about 6 hours and about 8 hours. In certain embodiments, the incubation time is between 3 hours and about 12 hours.

Following completion of the incubation in step 205, the soy culture mixture is converted to a fermented soy composition. In step 206 of FIG. 3, the fermented soy culture is strained to remove any excess liquid and provide the soy yogurt composition.

In some embodiments, the soy yogurt compositions produced by the methods herein may be described in terms of their high protein content. In some embodiments, the soy yogurt compositions have similar protein content per gram of soy solids as the soy milk compositions from which they were obtained. For example, in some embodiments, the soy yogurt composition comprises at least about 0.4 g, at least about 0.41 g, at least about 0.42 g, at least about 0.43 g, at least about 0.44 g, at least about 0.45 g, at least about 0.46 g, at least about 0.47 g, at least about 0.48 g, at least about 0.49 g, at least about 0.5 g, at least about 0.51 g, or at least about 0.52 g of soy protein per 1 g of soy solids. In certain embodiments, the soy yogurt composition comprises at least about 0.4 g, at least about 0.42 g, at least about 0.44 g, at least about 0.48 g, or at least about 0.5 g of soy protein per 1 g of soy solids. In certain embodiments, the soy yogurt composition comprises at least about 0.4 g of soy protein per 1 g of soy solids. In certain other embodiments, the soy yogurt composition comprises at least about 0.42 g of soy protein per 1 g of soy solids. In still other embodiments, the soy yogurt composition comprises at least about 0.44 g of soy protein per 1 g of soy solids. In yet certain other embodiments, the soy yogurt composition comprises at least about 0.48 g of soy protein per 1 g of soy solids. In still other embodiments, the soy yogurt composition comprises at least about 0.5 g of soy protein per 1 g of soy solids. In some embodiments, the soy yogurt composition comprises between about 0.4 g and about 0.8 g of soy protein per 1 g of soy solids.

In some embodiments, the soy yogurt compositions as produced by the methods described in the present section may be further characterized by the content of certain nutritional components and/or sensory characteristics as detailed in Section B below.

It should be noted that the foregoing methods may include variations of other parameters that may be part of the steps described herein. It should be understood that, in other variations, process 200 may include additional processing steps. In yet other variations, certain steps in process 200 may be omitted.

### IV. Methods of Producing Soy Frozen Dessert Compositions

In some aspects, the present disclosure further provides methods of producing soy frozen dessert compositions having a high protein content. In one aspect, provided herein is a method for producing a soy frozen dessert composition, comprising providing soybeans having a high protein content and processing the soybeans to produce a soy milk composition having a high protein content, and further processing the soy milk composition having a high protein content to produce a soy frozen dessert composition having a high protein content. In yet another aspect, provided herein is a method of producing a soy frozen dessert composition comprising providing a soy milk composition having a high protein content, and processing the soy milk composition having a high protein content to produce a soy frozen dessert composition. In some embodiments, the soy milk composition comprises at least about 0.4 g of soy protein per g soy solids or at least about 4 g of soy protein per 100 mL of liquid volume. In some embodiments, the soy milk composition may be produced according to the methods as described herein.

In one aspect, provided herein is a method of producing a soy frozen dessert composition, comprising a) providing a soy milk composition comprising at least about 0.4 g of soy protein per g of soy solids; b) combining the soy milk composition with sugar, a thickening agent, and one or more flavoring agents, to provide a frozen dessert base mixture; c) heating the frozen dessert base to provide a heated frozen dessert base mixture; d) chilling the heated frozen dessert base mixture, optionally straining the heated frozen dessert base mixture prior to chilling, to provide a chilled frozen dessert base mixture; and e) churning the chilled frozen dessert base mixture at a suitable time and temperature, and optionally freezing the churned frozen dessert base mixture, to provide a soy frozen dessert composition.

In another aspect, provided herein is a method for producing a soy frozen dessert composition, comprising a) providing a soy milk composition comprising at least about 4 g of soy protein per 100 mL of liquid volume of the soy milk composition; b) combining the soy milk composition with sugar, a thickening agent, and one or more flavoring agents, to provide a frozen dessert base mixture; c) heating the frozen dessert base to provide a heated frozen dessert base mixture; d) chilling the heated frozen dessert base mixture, optionally straining the heated frozen dessert base mixture prior to chilling, to provide a chilled frozen dessert base mixture; and e) churning the chilled frozen dessert base mixture at a suitable time and temperature, and optionally freezing the churned frozen dessert base mixture, to provide a soy frozen dessert composition.

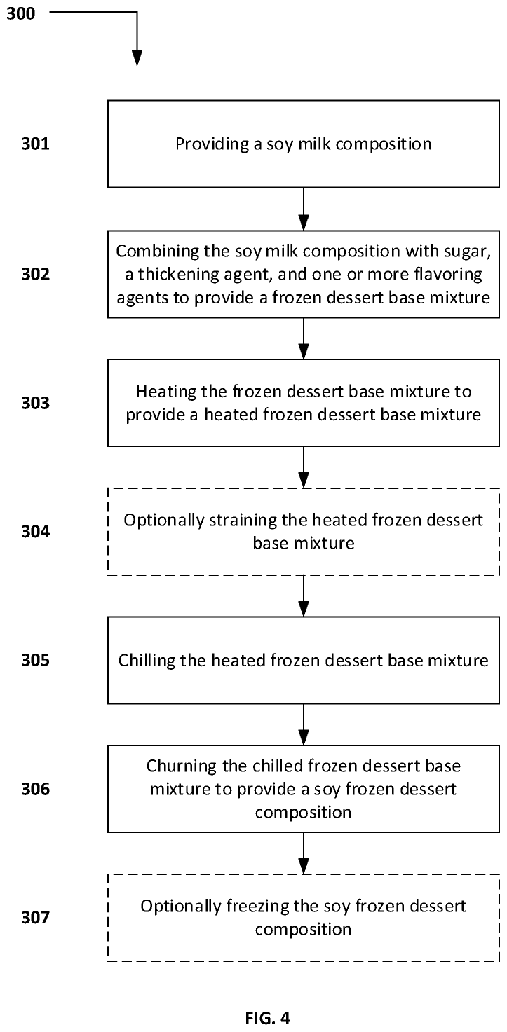

With reference to FIG. 4, process 300 is an exemplary process to prepare a soy frozen dessert composition having high protein content according to the present disclosure. In step 301, a soy milk composition having a high protein content is provided. In some embodiments, the soy milk composition comprises at least about 0.4 g, at least about 0.41 g, at least about 0.42 g, at least about 0.43 g, at least about 0.44 g, at least about 0.45 g, at least about 0.46 g, at least about 0.47 g, at least about 0.48 g, at least about 0.49 g, at least about 0.5 g, at least about 0.51 g, or at least about 0.52 g of soy protein per 1 g of soy solids. In certain embodiments, the soy milk composition comprises at least about 0.4 g, at least about 0.42 g, at least about 0.44 g, at least about 0.48 g, or at least about 0.5 g of soy protein per 1 g of soy solids. In certain embodiments, the soy milk composition comprises at least about 0.4 g of soy protein per 1 g of soy solids. In certain other embodiments, the soy milk composition comprises at least about 0.42 g of soy protein per 1 g of soy solids. In still other embodiments, the soy milk composition comprises at least about 0.44 g of soy protein per 1 g of soy solids. In yet certain other embodiments, the soy milk composition comprises at least about 0.48 g of soy protein per 1 g of soy solids. In still other embodiments, the soy milk composition comprises at least about 0.5 g of soy protein per 1 g of soy solids. In some embodiments, the soy milk composition comprises between about 0.4 g and about 0.8 g of soy protein per 1 g of soy solids.

In other embodiments, the soy milk composition comprises at least about 4 g, at least about 4.1 g, at least about 4.2 g, at least about 4.3 g, at least about 4.4 g, at least about 4.5 g, at least about 4.6 g, at least about 4.7 g, at least about 4.8 g, at least about 4.9 g, at least about 5 g, at least about 5.1 g or at least about 5.2 g of soy protein per 100 mL of liquid volume of soy milk composition. In some embodiments, the soy milk composition comprises at least about 4 g, at least about 4.2 g, at least bout 4.4 g, at least about 4.8 g or at least about 5 g of soy protein per 100 mL of liquid volume. In certain embodiments, the soy milk composition comprises at least about 4 g of soy protein per 100 mL of liquid volume. In certain other embodiments, the soy milk composition comprises at least about 4.2 g of soy protein per 100 mL of liquid volume. In still other embodiments, the soy milk composition comprises at least bout 4.4 g of soy protein per 100 mL of liquid volume. In yet certain other embodiments, the soy milk composition comprises at least about 4.8 g of soy protein per 100 mL of liquid volume. In still other embodiments, the soy milk composition comprises at least about 5 g of soy protein per 100 mL of liquid volume. In some embodiments, the soy milk composition comprises between about 4 g and about 10 g of soy protein per 100 mL of liquid volume.

In some embodiments, the soy milk composition is produced from soybeans having a high protein content as described herein. In some embodiments, the soy milk composition may be produced according to the methods as described herein. In some embodiments, the soy milk compositions as produced by the methods described in the present section may be further characterized by the content of certain nutritional components and/or sensory characteristics as detailed in Section B below.

In some variations, the step of providing the soy milk composition may encompass pasteurization of the soy milk composition. In some embodiments the soy milk composition is heated to a temperature of at least about 50° C., at least about 60° C., at least about 70° C., or at least about 80° C. In other embodiments, the soy milk composition is heated to a temperature of less than or equal to 100° C., less than or equal to 90° C., or less than or equal to 80° C. In some embodiments, the soy milk composition is heated to a temperature of between about 50° C. and about 100° C., between about 60° C. and about 90° C., between about 70° C. and about 80° C., or between about 70° C. and about 90° C. In certain embodiments, the soy milk composition is heated to a temperature of between about 70° C. and about 90° C.

With reference again to FIG. 4, in step 302, the soy milk composition is combined with sugar and a thickening agent, e.g., corn syrup, and optionally one or more flavoring agents, e.g., salt, vanilla extract, etc., to provide a frozen dessert base mixture. In some embodiments, the step of combining may encompass mixing, blending, and/or agitation to aid in distribution of the thickening and one or more flavoring agents in the soy milk composition.

In step 303, the frozen dessert base mixture is heated to further facilitate uniform dissolution and distribution of the thickening and one or more flavoring agents in the soy milk composition. In some embodiments, the frozen dessert base mixture is heated to a temperature of at least about 30° C., at least about 35° C., at least about 40° C., at least about 45° C., at least about 50° C., at least about 60° C., or at least about 70° C. In other embodiments, the frozen dessert base mixture is heated to a temperature of less than or equal to about 90° C., less than or equal to about 80° C., less than or equal to about 70° C., less than or equal to about 60° C., or less than or equal to about 50° C. In yet other embodiments, the frozen dessert base mixture is heated to a temperature of between about 30° C. and about 90° C., between about 30° C. and about 80° C., between about 30° C. and about 70° C., between about 30° C. and about 60° C., or between about 30° C. and about 50° C., between about 40° C. and about 90° C., between about 40° C. and about 80° C., between about 40° C. and about 70° C., between about 40° C. and about 60° C., or between about 40° C. and about 50° C.

After heating, the heated frozen dessert mixture is optionally strained to remove any unwanted solid or particulates from the frozen dessert base mixture prior to being chilled and churned. In some embodiments, the methods of the present disclosure may comprise a step 304 of straining the heated frozen dessert base mixture.

With reference again to FIG. 4, in step 305, the heated (optionally strained) frozen dessert base mixture is chilled to provide a chilled frozen dessert base mixture suitable for churning. In some embodiments, the heated frozen dessert base mixture is chilled to a temperature of less than or equal to about 10° C., less than or equal to about 9° C., less than or equal to about 8° C., less than or equal to about 7° C., less than or equal to about 6° C. or less than or equal to about 5° C. In other embodiments, the heated frozen dessert base mixture is chilled to a temperature of at least about 0° C., at least about 1° C., at least about 2° C., at least about 3° C., or at least about 4° C. In some embodiments, the heated frozen dessert base mixture is chilled to a temperature of between about 0° C. and about 10° C., between about 2° C. and about 8° C., between about 4° C. and about 6° C., between about 4° C. and about 10° C., or between about 4° C. and about 8° C. In certain embodiments, the frozen dessert base mixture is chilled to a temperature of less than or equal to about 10° C.

After being chilled to a suitable temperature, the chilled frozen dessert base mixture is churned in step 306. The step of churning aerates the chilled frozen dessert base to increase the volume of the frozen dessert base mixture. Churning can be performed by hand or using any suitable techniques and/or equipment known in the art. For example, churning can be performed using equipment such a paddle mixer.

In some variations, the chilled cream base mixture may be churned at a certain rotational speed, at a specified churning temperature for a specified duration of time. In some embodiments, the chilled frozen dessert base mixture may be churned at a temperature of less than or equal to about while also optionally allowing the frozen dessert base mixture to be cooled freezing temperatures. In some embodiments, the chilled frozen dessert base is churned at a temperature of less than or equal to about 4° C., less than or equal to about 3° C., less than or equal to about 2° C., less than or equal to about 1° C., or less than or equal to about 0° C. In other embodiments, the chilled frozen dessert is churned at a temperature of at least about −5° C., at least about −4° C., at least about −3° C., at least about −2° C., at least about −1° C. or at least about 0° C. In some embodiments, the chilled frozen dessert base mixture is churned for a period of at least about 5 minutes, at least about 10 minutes, at least about 15 minutes, at least about 20 minutes, at least about 30 minutes or at least about 45 minutes. In other embodiments, the chilled frozen dessert base mixture is churned for a period of less than or equal to about 120 minutes, less than or equal to about 90 minutes, less than or equal to about 75 minutes, less than or equal to about 60 minutes, less than or equal to about 45 minutes, less than or equal to about 30 minutes or less than or equal to about 15 minutes. In some embodiments, the step of churning the chilled frozen dessert base mixture provides a churned frozen dessert base mixture which can be consumed as a soy frozen dessert composition.

In some variations, with reference again to FIG. 4, in optional step 307, the churned frozen dessert base mixture may be further subjected to a freezing step to facilitate further solidification, depending on the desired consistency, to provide a soy frozen dessert composition. In some embodiments, the churned frozen dessert base mixture is frozen at a temperature of less than or equal to about 0° C., less than or equal to about −1° C., less than or equal to about −2° C., less than or equal to about −3° C., less than or equal to about −4° C., or less than or equal to about −5° C. In other embodiments, the churned frozen dessert base mixture is frozen at a temperature of at least about −20° C., at least about −18° C., at least about −15° C., at least about −12° C., or at least about −10° C. In some embodiments, the churned frozen dessert base mixture is frozen for a period of at least 3 hours, at least 4 hours, at least 5 hours, at least 6 hours, at least 8 hours, at least 10 hours or at least 12 hours. In other embodiments, the churned frozen dessert base mixture is frozen for a period of less than or equal to about 48 hours, less than or equal to about 36 hours, less than or equal to about 24 hours, less than or equal to about 20 hours, less than or equal to about 18 hours, or less than or equal to about 15 hours.

In some embodiments, the soy frozen dessert compositions produced by the methods herein may be described in terms of their high protein content. In some embodiments, the soy frozen dessert compositions have similar protein content per gram of soy solids as the soy milk compositions from which they were obtained. For example, in some embodiments, the soy frozen dessert composition comprises at least about 0.4 g, at least about 0.41 g, at least about 0.42 g, at least about 0.43 g, at least about 0.44 g, at least about 0.45 g, at least about 0.46 g, at least about 0.47 g, at least about 0.48 g, at least about 0.49 g, at least about 0.5 g, at least about 0.51 g, or at least about 0.52 g of soy protein per 1 g of soy solids. In certain embodiments, the soy frozen dessert composition comprises at least about 0.4 g, at least about 0.42 g, at least about 0.44 g, at least about 0.48 g, or at least about 0.5 g of soy protein per 1 g of soy solids. In certain embodiments, the soy frozen dessert composition comprises at least about 0.4 g of soy protein per 1 g of soy solids. In certain other embodiments, the soy frozen dessert composition comprises at least about 0.42 g of soy protein per 1 g of soy solids. In still other embodiments, the soy frozen dessert composition comprises at least about 0.44 g of soy protein per 1 g of soy solids. In yet certain other embodiments, the soy yogurt composition comprises at least about 0.48 g of soy protein per 1 g of soy solids. In still other embodiments, the soy frozen dessert composition comprises at least about 0.5 g of soy protein per 1 g of soy solids. In some embodiments, the soy frozen dessert composition comprises between about 0.4 g and about 0.8 g of soy protein per 1 g of soy solids.

In some embodiments, the soy frozen dessert compositions as produced by the methods described in the present section may be further characterized by the content of certain nutritional components and/or sensory characteristics as detailed in Section B below.

It should be noted that the foregoing methods may include variations of other parameters that may be part of the steps described herein. It should be understood that, in other variations, process 300 may include additional processing steps. In yet other variations, certain steps in process 300 may be omitted.

B. Soy Milk Compositions, Soy Yogurt Compositions, and Soy Frozen Dessert Compositions

In some aspects, the present disclosure provides soy milk compositions, soy yogurt compositions, and soy frozen dessert compositions having high protein content. The soy milk compositions, soy yogurt compositions, and soy frozen dessert compositions may also possess one or more additional favorable characteristics derived from the source soybeans utilized to prepare the soy compositions in addition to their high protein content. Such favorable characteristics may include, for example, high oleic acid content, low indigestible oligosaccharide content, and more specifically, low raffinose and/or low stachyose content, and/or low total glycitein compounds content.

### I. Soy Milk Compositions

In one aspect, provided herein are soy milk compositions having high protein content. In another aspect, provided herein are soy milk compositions having 0.4 g soy protein per g of soy solids. In yet another aspect, provided herein are soy milk compositions having 4 g of soy protein per 100 mL of liquid volume of the soy milk composition. In still yet another aspect, provided herein are soy milk compositions obtained by or obtainable from the methods of the present disclosure for producing soy milk compositions.

The soy milk compositions as provided herein have nutritional contents that directly reflect the source soybean varieties from which they were produced-including, for example, protein content, fat content, oligosaccharide content and other content. Accordingly, the soy milk compositions of the present disclosure may be characterized in terms of their protein content, fat content-including monounsaturated fat content, and more specifically oleic and linoleic acid content, raffinose and stachyose content, and total glycitein compounds content.

It should be recognized that soy milk compositions may be characterized in terms of content of any components per gram of soy solids, per unit volume (e.g., per 100 mL of liquid volume), or with reference to a certain serving size, such as for a specified volume, e.g., per 8 fluid ounces. In other embodiments, the compositions provided herein may be characterized in terms of ratios, e.g., the content of one component relative to the content of a second component.

### a) Protein Content

The present disclosure provides soy milk compositions having high protein content. In some embodiments, the soy milk composition comprises at least about 0.4 g, at least about 0.41 g, at least about 0.42 g, at least about 0.43 g, at least about 0.44 g, at least about 0.45 g, at least about 0.46 g, at least about 0.47 g, at least about 0.48 g, at least about 0.49 g, at least about 0.5 g, at least about 0.51 g, or at least about 0.52 g of soy protein per 1 g of soy solids. In certain embodiments, the soy milk composition comprises at least about 0.4 g, at least about 0.42 g, at least about 0.44 g, at least about 0.48 g, or at least about 0.5 g of soy protein per 1 g of soy solids. In certain embodiments, the soy milk composition comprises at least about 0.4 g of soy protein per 1 g of soy solids. In certain other embodiments, the soy milk composition comprises at least about 0.42 g of soy protein per 1 g of soy solids. In still other embodiments, the soy milk composition comprises at least about 0.44 g of soy protein per 1 g of soy solids. In yet certain other embodiments, the soy milk composition comprises at least about 0.48 g of soy protein per 1 g of soy solids. In still other embodiments, the soy milk composition comprises at least about 0.5 g of soy protein per 1 g of soy solids. In some embodiments, the soy milk composition comprises between about 0.4 g and about 0.8 g, between about 0.42 g and about 0.8 g, between about 0.44 g and about 0.8 g, between about 0.46 g and about 0.8 g, between about 0.48 g and about 0.8 g, or between about 0.5 g and about 0.8 g, of soy protein per 1 g of soy solids.

In other embodiments, the soy milk composition comprises at least about 4 g, at least about 4.1 g, at least about 4.2 g, at least about 4.3 g, at least about 4.4 g, at least about 4.5 g, at least about 4.6 g, at least about 4.7 g, at least about 4.8 g, at least about 4.9 g, at least about 5 g, at least about 5.1 g or at least about 5.2 g of soy protein per 100 mL of liquid volume of soy milk composition. In some embodiments, the soy milk composition comprises at least about 4 g, at least about 4.2 g, at least about 4.4 g, at least about 4.8 g or at least about 5 g of soy protein per 100 mL of liquid volume. In certain embodiments, the soy milk composition comprises at least about 4 g of soy protein per 100 mL of liquid volume. In certain other embodiments, the soy milk composition comprises at least about 4.2 g of soy protein per 100 mL of liquid volume. In still other embodiments, the soy milk composition comprises at least bout 4.4 g of soy protein per 100 mL of liquid volume. In yet certain other embodiments, the soy milk composition comprises at least about 4.8 g of soy protein per 100 mL of liquid volume. In still other embodiments, the soy milk composition comprises at least about 5 g of soy protein per 100 mL of liquid volume. In some embodiments, the soy milk composition comprises between about 4 g and about 10 g, between about 4.2 g and about 10 g, between about 4.4 g and about 10 g, between about 4.6 g and about 10 g, between about 4.8 g and about 10 g, or between about 5 g and about 10 g of soy protein per 100 mL of liquid volume.

In yet other embodiments, the protein content of the soy milk compositions provided herein may be characterized with reference to a serving size. In some embodiments, a serving size is 8 fluid ounces (fl. oz.). In some embodiments, the soy milk composition comprises at least about 8 g, at least about 9 g, at least about 10 g, at least about 11 g, at least about 12 g, at least about 13 g, at least about 14 g, or at least about 15 g of protein per 8 fl. oz. serving. In certain embodiments, the soy milk composition comprises at least about 8 g of protein per 8 fl. oz. In certain other embodiments, the soy milk composition comprises at least about 13 g of protein per 8 fl. oz. In some embodiments, the soy milk compositions provided herein comprise between about 8 g and about 20 g, between about 9 g and about 20 g, between about 10 g and about 20 g, between about 11 g and about 20 g, between about 12 g and about 20 g, between about 13 g and about 20 g, between about 14 g and about 20 g, or between about 15 g and about 20 g of soy protein per 8 fl. oz. serving.

The soy milk compositions as provided herein notably do not contain protein from external sources—including, for example, processed soy protein concentrates and/or protein isolates—beyond the source soybeans directly used to prepare the soy milk compositions.

In some embodiments, the protein present in the soy milk composition is protein obtained from the same source soybeans from which the oleic acid, raffinose, stachyose, and/or total glycitein compounds present in the soy milk composition were derived. In other embodiments, the soy milk composition is substantially free of soy protein concentrate or soy protein isolate. In still other embodiments, the soy milk composition is substantially free of protein obtained from non-soybean sources or soybean sources other than the soybeans from which the oleic acid, raffinose, stachyose, and/or total glycitein compounds present in the soy milk composition were derived.

### b) Fat Content

In some embodiments, the soy milk composition comprises at least about 0.2 g, at least about 0.4 g, at least about 0.5 g, at least about 0.7 g, at least about 1 g, at last about 1.2 g, at least about 1.5 g, at least about 1.7 g, at least about, at least about 2 g, at least about 2.2 g, or at least about 2.5 g oleic acid per 100 mL of liquid volume. In some embodiments, the soy milk composition comprises at least about 0.5 g oleic acid per 100 mL of liquid volume. In some embodiments, the soy milk composition comprises at least about 1 g oleic acid per 100 mL of liquid volume. In some embodiments, the soy milk composition comprises at least about 1.5 g oleic acid per 100 mL of liquid volume. In some embodiments, the soy milk composition comprises at least about 2 g oleic acid per 100 mL of liquid volume. In some embodiments, the soy milk composition comprises at between about 0.2 g and about 3 g oleic acid per 100 mL of liquid volume.

In other embodiments, the soy milk composition comprises at least about 50 mg, at least about 60 mg, at least about 70 mg, at least about 80 mg, at least about 90 mg, at least about 100 mg, at least about 120 mg, at least about 130 mg, at least about 140 mg, or at least about 150 mg oleic acid per 1 g of soy solids. In certain embodiments, the soy milk composition comprises at least about 150 mg oleic acid per 1 g of soy solids. In some embodiments, the soy milk composition comprises between about 50 mg and about 200 mg oleic acid per 1 g of soy solids.

In other embodiments, the soy milk composition comprises at least about 30%, at least about 40%, at least about 50%, at least about 60%, or at least about 70% w/w oleic acid of the total fatty acid content. In certain embodiments, the soy milk composition comprises at least about 70% of oleic acid of the total fatty acid content.

In some embodiments, the soy milk compositions of the present disclosure may be characterized by their fat content per serving size. In some embodiments, a serving size is 8 fluid ounces (fl. oz.).

In some embodiments, the soy milk composition comprises at least about 1 g, at least about 2 g, at least about 3 g, or at least about 4 g of monounsaturated fats per 8 fluid ounces. In certain embodiments, the soy milk composition comprises at least about 4 g of monounsaturated fats per 8 fluid ounces.

### c) Raffinose and Stachyose Content

In some embodiments, the soy milk composition comprises less than or equal to about 60 mg, less than or equal to about 50 mg, less than or equal to about 40 mg, or less than or equal to about 30 mg raffinose per 100 mL of liquid volume. In certain embodiments, the soy milk composition comprises less than or equal to about 30 mg raffinose per 100 mL of liquid volume. In some embodiments, the soy milk composition comprises between about 0 mg and about 30 mg raffinose per 100 mL of liquid volume. In some embodiments, the soy milk composition comprises less than or equal to about 10 mg, less than or equal to about 9 mg, less than or equal to about 8 mg, less than or equal to about 7 mg raffinose per 1 g of soy solids. In certain embodiments, the soy milk composition comprises less than or equal to about 7 mg raffinose per 1 g of soy solids. In some embodiments, the soy milk composition comprises between about 0 mg and about 7 mg raffinose per 1 g of soy solids.

In some embodiments, the soy milk composition comprises less than or equal to about 300 mg, less than or equal to about 250 mg, less than or equal to about 200 mg, less than or equal to about 150 mg or less than or equal to about 100 mg stachyose per 100 mL of liquid volume. In certain embodiments, the soy milk composition comprises less than or equal to about 100 mg stachyose per 100 mL of liquid volume. In some embodiments, the soy milk composition comprises between about 0 mg and about 100 mg stachyose per 100 mL of liquid volume. In some embodiments, the soy milk composition comprises less than or equal to about 20 mg, less than or equal to about 17 mg, less than or equal to about 15 mg, less than or equal to about 12 mg or less than or equal to about 10 mg stachyose per 1 g of soy solids. In certain embodiments, the soy milk composition comprises less than or equal to about 10 mg stachyose per 1 g of soy solids. In certain embodiments, the soy milk composition comprises between about 0 mg and about 10 mg stachyose per 1 g of soy solids.

In some embodiments, the soy milk composition comprises less than or equal to about 400 mg, less than or equal to about 350 mg, less than or equal to about 300 mg, less than or equal to about 250 mg, less than or equal to about 200 mg, or less than or equal to about 150 mg combined raffinose and stachyose per 100 mL of liquid volume. In certain embodiments, the soy milk composition comprises less than or equal to about 150 mg combined raffinose and stachyose per 100 mL of liquid volume. In certain embodiments, the soy milk composition comprises between about 0 mg and about 150 mg combined raffinose and stachyose per 100 mL of liquid volume. In other embodiments, the soy milk composition comprises less than or equal to about 40 mg, less than or equal to about 35 mg, less than or equal to about 30 mg, less than or equal to about 25 mg, or less than or equal to about 20 mg combined raffinose and stachyose per 1 g of soy solids. In certain other embodiments, the soy milk composition comprises less than or equal to about 20 mg combined raffinose and stachyose per 1 g of soy solids. In some embodiments, the soy milk composition comprises between about 0 mg and about 20 mg combined raffinose and stachyose per 1 g of soy solids.

In certain embodiments, the soy milk composition comprises less than or equal to about 30 mg raffinose per 100 mL of liquid volume and less than or equal to about 100 mg stachyose per 100 mL of liquid volume. In certain other embodiments, the soy milk composition comprises less than or equal to about 7 mg raffinose per 1 g of soy solids and less than or equal to about 10 mg stachyose per 1 g of soy solids. In some embodiments, the soy milk composition comprises between about 0 mg and about 7 mg raffinose per 1 g of soy solids and between about 0 mg and about 10 mg stachyose per 1 g of soy solids.

In some embodiments, raffinose and stachyose together comprise less than about 50%, less than about 40%, less than about 30%, less than about 20%, less than about 15%, less than about 10%, or less than about 5% of the total sugars in the soy milk. In some embodiments, raffinose and stachyose together comprise less than about 5% of the total sugars in the soy milk. In some embodiments, sucrose comprises at least 50%, at least 60%, at least 70%, at least 80%, at least 85%, at least 90% or at least 95% of the total sugars in the soy milk. In some embodiments, sucrose comprises at least 85% of the total sugars in the soy milk. In some embodiments, sucrose comprises between about 50% and about 100% of the total sugars in the soy milk. In some embodiments, the soy milk has a sweet flavor. In some embodiments, the soy milk has a sweet flavor and contains no added sweeteners.

### d) Total Glycitein Compounds and Other Flavor Components

In some embodiments, the soy milk composition comprises less than or equal to about 0.5 mg, less than or equal to about 0.45 mg, less than or equal to about 0.4 mg, less than or equal to about 0.35 mg, or less than or equal to about 0.3 mg total glycitein compounds per 100 mL of liquid volume. In certain embodiments, the soy milk composition comprises less than or equal to about 0.5 mg total glycitein compounds per 100 mL of liquid volume. In certain embodiments, the soy milk composition comprises less than or equal to about 0.075 mg, less than or equal to about 0.07 mg, less than or equal to about 0.065 mg, less than or equal to about 0.06 mg, less than or equal to about 0.055 mg, or less than or equal to about 0.05 mg total glycitein compounds per 1 g soy solids. In certain embodiments, the soy milk composition comprises less than or equal to about 0.05 mg total glycitein compounds per 1 g soy solids. In some embodiments, the soy milk composition comprises between about 0 mg and about 0.05 mg total glycitein compounds per 1 g soy solids.

In some embodiments, the soy milk composition comprises less than or equal to about 1 g, less than or equal to about 0.5 g, less than or equal to about 0.1 g lipoxygenase per 100 mL of liquid volume. In certain embodiments, the soy milk composition comprises less than or equal to about 1 g lipoxygenase per 100 mL of liquid volume. In other embodiments, the soy milk composition further comprises less than or equal to about 0.1 g, less than or equal to about 0.05 g or less than or equal to about 0.01 g lipoxygenase per 1 g soy solids. In certain other embodiments, the soy milk composition further comprises less than or equal to about 0.1 g lipoxygenase per 1 g soy solids. In some embodiments, the soy milk composition comprises between about 0 g and about 0.1 g lipoxygenase per 1 g soy solids.

In some embodiments, the soy milk composition is produced from a soybean variety that has a low glycitein and/or glycitin content in the seeds of the soybeans, and the soy milk composition has a low perceived astringency, as assessed on a 15-point scale by a tasting panel. In some embodiments, the soy milk composition is produced from a soybean variety that has a glycitein and/or glycitin content of less than about 400 ppm, less than about 350 ppm, less than about 300 ppm, less than about 250 ppm, less than about 200 ppm, less than about 150 ppm, less than about 100 ppm, or less than about 50 ppm in the seeds of the soybeans, and the soy milk composition has a low perceived astringency, as assessed on a 15-point scale by a tasting panel. In some embodiments, the soy milk composition is produced from a soybean variety that has a glycitein and/or glycitin content of less than about 250 ppm, less than about 240 ppm, less than about 230 ppm, less than about 220 ppm, less than about 210 ppm, less than about 200 ppm, less than about 190 ppm, less than about 180 ppm, less than about 170 ppm, less than about 160 ppm, less than about 150 ppm, less than about 140 ppm, less than about 130 ppm, less than about 120 ppm, less than about 110 ppm, less than about 90 ppm, less than about 80 ppm, less than about 70 ppm, less than about 60 ppm, or less than about 50 ppm in the seeds of the soybeans, and the soy milk composition has a low perceived astringency, as assessed on a 15-point scale by a tasting panel. In some embodiments, the soy milk composition is produced from a soybean variety that has a glycitein and/or glycitin content of less than about 230 ppm in the seeds of the soybeans, and the soy milk composition has a perceived astringency of less than about 7, less than about 6, less than about 5, less than about 4, less than about 3, less than about 2, or less than about 1, as assessed on a 15-point scale by a tasting panel. In some embodiments, the soy milk composition is produced from a soybean variety that has a glycitein and/or glycitin content of less than about 230 ppm in the seeds of the soybeans, and the soy milk composition has a perceived astringency of less than about 3, as assessed on a 15-point scale by a tasting panel. In some embodiments, the soy milk composition is produced from a soybean variety that has a glycitein and/or glycitin content between about 0 ppm and about 400 ppm, between about 0 ppm and about 350 ppm, between about 0 ppm and about 300 ppm, between about 0 ppm and about 250 ppm, between about 0 ppm and about 200 ppm, between about 0 ppm and about 150 ppm, between about 0 ppm and about 100 ppm, or between about 0 ppm and about 50 ppm in the seeds of the soybeans. In some embodiments, the perceived astringency is assessed on a 15-point scale by a trained tasting panel according to the protocol described in Example 5.

### e) Caloric Content

In some embodiments, the soy milk compositions of the present disclosure may be characterized by their caloric content per serving size. In some embodiments, a serving size is 8 fluid ounces (fl. oz.).

In some embodiments, the soy milk composition comprises less than or equal to about 200 Calories, less than or equal to about 180 Calories, less than or equal to about 150 Calories, less than or equal to about 140 Calories, less than or equal to about 130 Calories, less than or equal to about 120 Calories, less than or equal to about 110 Calories, less than or equal to about 100 Calories, less than or equal to about 90 Calories, or less than or equal to about 80 Calories per 8 fl. oz. In certain embodiments, the soy milk composition comprises less than or equal to about 130 Calories. In certain other embodiments, the soy milk composition comprises less than or equal to about 80 Calories.

### f) Sensory Characteristics

The soy milk compositions of the present disclosure may also be characterized by one or more sensory characteristic properties, including physical characteristics—e.g., color, viscosity, grittiness, chalkiness, mouthfeel—and flavor characteristics.

The color of the soy milk compositions may be assessed visually or with reference to a standard color chart. As detailed herein, the soy milk compositions may be prepared from soybean varieties having hilum color that is yellow, white or clear. Light-colored hila are favored as they may result in lighter colored soy compositions downstream. In some embodiments, the soy milk composition of the present disclosure is white. In certain embodiments, the soy milk composition is white.

Textural or flavor characteristics of the soy milk compositions may be assessed by means of a formal tasting panel. In some embodiments, the presence or absence of one or more sensory attributes may be quantified on a numerical scale (e.g., 1 to 5, 1 to 10, or 1 to 15) based on the perceived intensity of each flavor attribute, relative to a standard soy milk reference, such as a commercially available soy milk product.

In some embodiments, the soy milk compositions of the present disclosure may be characterized by the presence or absence of one or more sensory attributes including, for example, soy flavor/notes, nuttiness, butteriness, grassiness, smoothness, sweetness, oiliness, astringency, sharpness, bitterness, and sourness. In some variations, the soy milk compositions have one or more sensory attributes selected from the group consisting of: soy flavor/notes, nuttiness, butteriness, grassiness, smoothness, sweetness, oiliness, astringency, sharpness, bitterness, and sourness, and any combinations thereof. In some embodiments, the soy milk compositions are characterized by the absence of astringency. In some embodiments, the soy milk compositions are characterized by the presence of sweetness.

In some embodiments, the soy milk compositions of the present disclosure are characterized by the absence of an umami flavor/note. In some embodiments, the soy milk compositions have perceived umami flavor of less than about 7, less than about 6, less than about 5, less than about 4, less than about 3, less than about 2, or less than about 1, as assessed on a 15-point scale by a tasting panel. In some embodiments, the soy milk compositions have perceived umami flavor of between about 0 and about 7, between about 0 and about 6, between about 0 and about 5, between about 0 and about 4, between about 0 and about 3, between about 0 and about 2, or between about 0 and about 1, as assessed on a 15-point scale by a tasting panel. Without wishing to be bound by theory, it is believed that umami flavor may be derived from the presence of free amino acids in a soy milk, including, for example, glutamic acid or glutamate, aspartic acid or aspartate, arginine, and/or histidine. In some embodiments, the soy milk composition has a glutamic acid concentration that is less than about 14 μM, less than about 12 μM, less than about 10 μM, less than about 8 μM, less than about 6 μM, or less than about 4 μM. In some embodiments, the soy milk composition has an aspartic acid concentration that is less than about 15 μM, less than about 14 μM, less than about 13 μM, less than about 12 μM, less than about 11 μM, or less than about 10 μM. In some embodiments, the soy milk composition has a histidine concentration that is less than about 2 μM, less than about 1.8 μM, less than about 1.6 μM, less than about 1.4 μM, less than about 1.2 μM, or less than about 1 μM. In some embodiments, the soy milk composition has an arginine concentration that is less than about 45 μM, less than about 44 μM, less than about 43 μM, less than about 42 μM, less than about 41 μM, less than about 40 μM, less than about 39 μM, less than about 38 μM, less than about 37 μM, less than about 36 μM, or less than about 35 μM. In some embodiments, the soy milk composition has one or more of the following features: (i) a glutamic acid concentration that is less than about 10 μM, (ii) an aspartic acid concentration that is less than about 11 μM, (iii) a histidine concentration that is less than about 1.6 μM, or (iv) an arginine concentration that is less than about 39 μM. In some embodiments, the soy milk composition has one or more of the following features: (i) a glutamic acid concentration that is between about 0 μM and about 10 μM, (ii) an aspartic acid concentration that is between about 0 μM and about 11 μM, (iii) a histidine concentration that is between about 0 μM and about 1.6 μM, or (iv) an arginine concentration that is between about 0 μM and about 39 μM. In some embodiments, the soy milk composition has a glutamic acid concentration that is less than about 10 μM, an aspartic acid concentration that is less than about 11 μM, a histidine concentration that is less than about 1.6 μM, and an arginine concentration that is less than about 39 μM. In some embodiments, the soy milk composition has a glutamic acid concentration that is between about 0 μM and about 10 μM, an aspartic acid concentration that is between about 0 μM and about 11 μM, a histidine concentration that is between about 0 μM and about 1.6 μM, and an arginine concentration that is between about 0 μM and about 39 μM.

### g) Soy Solids Per Unit Volume

In some embodiments, the soy milk compositions may be characterized by the mass of soy solids per unit volume of liquid in the soymilk. The mass of soy solids per unit volume for a soy milk may impact the textural profile of the soy milk composition. For example, a soy milk with too high a mass of soy solids per unit volume may be perceived as “too thick”, a property which may be undesirable to consumers. Likewise, for soy milk compositions where a high protein content is targeted, the use of soybeans with too low of a germplasm protein content may require the inclusion of a greater mass of soy solids per unit volume to achieve the desired soy milk protein content, thus resulting in a soy milk that is perceived as “too thick”. Accordingly, the use of high protein soybeans may be advantageous for preparing high protein soy milk compositions with desirable textural properties.

In some embodiments, the soy milk has less than about 15 g, less than about 14 g, less than about 13 g, less than about 12 g, less than about 11 g, or less than about 10 g of soy solids per 100 mL of soy milk. In other embodiments, the soy milk has less than or equal to about 15 g, less than or equal to about 14 g, less than or equal to about 13 g, less than or equal to about 12 g, less than or equal to about 11 g, or less than or equal to about 10 g of soy solids per 100 mL of soy milk. In some embodiments, the soy milk has between about 10 g and about 14 g of soy solids per 100 mL of soy milk. In certain embodiments, the soy milk has between about 11 g and about 13 g of soy solids per 100 mL of soy milk. In some embodiments, the soy milk has at least about 4 g of soy protein per 100 mL of soy milk and between about 11 g and about 13 g of soy solids per 100 mL of soy milk. In some embodiments, the soy milk has at least about 5 g of soy protein per 100 mL of soy milk and between about 11 g and about 13 g of soy solids per 100 mL of soy milk.

In some embodiments, the soy milk can be characterized by its viscosity, as measured, for example, in centipoise (cP). In some embodiments, the soy milk has a viscosity of between about 20 cP and about 50 cP, between about 20 cP and about 40 cP, or between about 20 cP and about 30 cP. In some embodiments, the soy milk has a viscosity of between about 20 cP and about 40 cP In some embodiments, the soy milk has a viscosity of between about 20 cP and about 30 cP. In some embodiments, the soy milk has at least 4 g of soy protein per 100 mL of soy milk and a viscosity of between about 20 cP and about 40 cP, or between about 20 cP and about 30 cP. In some embodiments, the soy milk has at least 5 g of soy protein per 100 mL of soy milk and a viscosity of between about 20 cP and about 40 cP, or between about 20 cP and about 30 cP. In some embodiments, the soy milk has at least 4 g of soy protein per 100 mL of soy milk, between about 11 g and about 13 g of soy solids per 100 mL of soy milk, and a viscosity of between about 20 cP and about 40 cP, or between about 20 cP and about 30 cP. In some embodiments, the soy milk has at least 5 g of soy protein per 100 mL of soy milk, between about 11 g and about 13 g of soy solids per 100 mL of soy milk, and a viscosity of between about 20 cP and about 40 cP, or between about 20 cP and about 30 cP.

### h) Exemplary Soy Milk Compositions

It should be understood that the embodiments of the soy milk composition, for example, directed to protein content, raffinose and/or stachyose content, glycitein and/or glycitein content, sweetness, umami, and the mass of soy solids per unit volume, may be combined as if each and every combination were individually listed. For example, in one variation, the soy milk composition has at least about 4 g of protein per 100 mL of liquid volume, less than or equal to 30 mg of raffinose per 100 mL of liquid volume, and less than or equal to 100 mg of stachyose per 100 mL of liquid volume. In another variation, the soy milk composition further comprises less than about 15 g of soy solids per 100 mL of liquid volume. In another variation, the soy milk further comprises less than or equal to about 0.5 mg total glycitein compounds per 100 mL of liquid volume. In another variation, the soy milk further has a glutamic acid concentration that is less than about 10 μM, an aspartic acid concentration that is less than about 11 μM, a histidine concentration that is less than about 1.6 μM, and an arginine concentration that is less than about 39 μM. In another variation, the soy milk further has less than about 15 g of soy solids per 100 mL of soy milk.

In another variation, the soy milk composition is further characterized by a high perceived sweetness. In another variation, the soy milk composition is further characterized by a low perceived astringency. In another variation, the soy milk composition is further characterized by a low perceived umami flavor.

In one variation, the soy milk composition has at least about 4 g of protein per 100 mL of liquid volume, less than or equal to 30 mg of raffinose per 100 mL of liquid volume, less than or equal to 100 mg of stachyose per 100 mL of liquid volume, less than about 15 g of soy solids per 100 mL of liquid volume, less than or equal to about 0.5 mg total glycitein compounds per 100 mL of liquid volume, a glutamic acid concentration that is less than about 10 μM, an aspartic acid concentration that is less than about 11 μM, a histidine concentration that is less than about 1.6 μM, an arginine concentration that is less than about 39 μM, and less than about 15 g of soy solids per 100 mL of soy milk.

In some embodiments, the soy milk compositions may be characterized by the content one of more of nutrient components, including, for example, the presence of any aforementioned components (e.g., protein, fats, carbohydrates, calories, etc.) at certain quantities, and/or one or more of the physical and/or flavor sensory characteristics described herein.

In one aspect, provided herein is a soy milk composition, comprising: (i) less than or equal about 80 calories per 8 fluid ounces; (ii) at least about 8 g of protein per 8 fluid ounces; and (iii) at least about 4 g of monounsaturated fats per 8 fluid ounces.

In another aspect, provided herein is a soy milk composition, comprising: (i) less than or equal about 130 calories per 8 fluid ounces; (ii) at least about 13 g of protein per 8 fluid ounces; and (iii) at least about 4 g of monounsaturated fats per 8 fluid ounces.

In yet another aspect, provided herein is a soy milk composition, comprising: (i) about 140 calories per 8 fluid ounces; (ii) about 15 g of protein per 8 fluid ounces; (iii) about 6 g of fat per 8 fluid ounces; and (iv) about 3 g of sugar per 8 fluid ounces. In some variations, the soy milk does not contain any added sweeteners. In some variations, the soy milk do not contain protein from external sources—including, for example, processed soy protein concentrates and/or protein isolates. In some variations, the soy milk has at least one of the following features: (i) less than or equal to 30 mg of raffinose per 100 mL of liquid volume, (ii) less than or equal to 100 mg of stachyose per 100 mL of liquid volume, (iii) less than about 15 g of soy solids per 100 mL of liquid volume, (iv) less than or equal to about 0.5 mg total glycitein compounds per 100 mL of liquid volume, (v) a glutamic acid concentration that is less than about 10 μM, (vi) an aspartic acid concentration that is less than about 11 μM, (vii) a histidine concentration that is less than about 1.6 μM, (viii) an arginine concentration that is less than about 39 μM, or (ix) less than about 15 g of soy solids per 100 mL of soy milk, or any combination thereof.

### II. Soy Yogurt Compositions

In one aspect, provided herein are soy yogurt compositions having high protein content. In another aspect, provided herein are soy yogurt compositions having 0.4 g soy protein per g of soy solids. In still yet another aspect, provided herein are soy yogurt compositions obtained by or obtainable from the methods of the present disclosure for producing soy yogurt compositions.

The soy yogurt compositions as provided herein have nutritional contents that directly reflect the source soybean varieties from which they were produced-including, for example, protein content, fat content, oligosaccharide content and other content. Accordingly, the soy yogurt compositions of the present disclosure may be characterized in terms of their protein content, fat content—including monounsaturated fat content, and more specifically oleic and linoleic acid content, raffinose and stachyose content, and total glycitein compounds content.

It should be recognized that compositions may be characterized in terms of content of any components per gram of soy solids, per unit volume (e.g., per ounce), per unit weight (e.g., per gram of yogurt), or with reference to a certain serving size. In other embodiments, the compositions provided herein may be characterized in terms of ratios, e.g., the content of one component relative to the content of a second component.

### a) Protein Content

The present disclosure provides soy yogurt compositions having high protein content. In some embodiments, the soy yogurt composition comprises at least about 0.4 g, at least about 0.41 g, at least about 0.42 g, at least about 0.43 g, at least about 0.44 g, at least about 0.45 g, at least about 0.46 g, at least about 0.47 g, at least about 0.48 g, at least about 0.49 g, at least about 0.5 g, at least about 0.51 g, or at least about 0.52 g of soy protein per 1 g of soy solids. In certain embodiments, the soy yogurt composition comprises at least about 0.4 g, at least about 0.42 g, at least about 0.44 g, at least about 0.48 g, or at least about 0.5 g of soy protein per 1 g of soy solids. In certain embodiments, the soy yogurt composition comprises at least about 0.4 g of soy protein per 1 g of soy solids. In certain other embodiments, the soy yogurt composition comprises at least about 0.42 g of soy protein per 1 g of soy solids. In still other embodiments, the soy yogurt composition comprises at least about 0.44 g of soy protein per 1 g of soy solids. In yet certain other embodiments, the soy yogurt composition comprises at least about 0.48 g of soy protein per 1 g of soy solids. In still other embodiments, the soy yogurt composition comprises at least about 0.5 g of soy protein per 1 g of soy solids. In some embodiments, the soy yogurt composition comprises between about 0.4 g and about 0.8 g of soy protein per 1 g of soy solids.

In other embodiments, the soy yogurt composition comprises at least about 4 g, at least about 4.1 g, at least about 4.2 g, at least about 4.3 g, at least about 4.4 g, at least about 4.5 g, at least about 4.6 g, at least about 4.7 g, at least about 4.8 g, at least about 4.9 g, at least about 5 g, at least about 5.1 g or at least about 5.2 g of soy protein per 100 g of soy yogurt composition of soy yogurt composition. In some embodiments, the soy yogurt composition comprises at least about 4 g, at least about 4.2 g, at least bout 4.4 g, at least about 4.8 g or at least about 5 g of soy protein per 100 g of soy yogurt composition. In certain embodiments, the soy yogurt composition comprises at least about 4 g of soy protein per 100 g of soy yogurt composition. In certain other embodiments, the soy yogurt composition comprises at least about 4.2 g of soy protein per 100 g of soy yogurt composition. In still other embodiments, the soy yogurt composition comprises at least bout 4.4 g of soy protein per 100 g of soy yogurt composition. In yet certain other embodiments, the soy yogurt composition comprises at least about 4.8 g of soy protein per 100 g of soy yogurt composition. In still other embodiments, the soy yogurt composition comprises at least about 5 g of soy protein per 100 g of soy yogurt composition. In some embodiments, the soy yogurt composition comprises between about 4 g and about 10 g of soy protein per 100 g of soy yogurt composition.

The soy yogurt compositions as provided herein notably do not contain protein from external sources—including, for example, processed soy protein concentrates and/or protein isolates—beyond the source soybeans directly used to prepare the soy yogurt compositions.

In some embodiments, the protein present in the soy yogurt composition is protein obtained from the same source soybeans from which the oleic acid, raffinose, stachyose, and/or total glycitein compounds present in the soy yogurt composition were derived. In other embodiments, the soy yogurt composition is substantially free of soy protein concentrate or soy protein isolate. In still other embodiments, the soy yogurt composition is substantially free of protein obtained from non-soybean sources or soybean sources other than the soybeans from which the oleic acid, raffinose, stachyose, and/or total glycitein compounds present in the soy yogurt composition were derived.

### b) Fat Content

In some embodiments, the soy milk composition comprises at least about 0.2 g, at least about 0.4 g, at least about 0.5 g, at least about 0.7 g, at least about 1 g, at last about 1.2 g, at least about 1.5 g, at least about 1.7 g, at least about, at least about 2 g, at least about 2.2 g, or at least about 2.5 g oleic acid per 100 g of soy yogurt composition. In some embodiments, the soy yogurt composition comprises at least about 1 g oleic acid per 100 g of soy yogurt composition. In some embodiments, the soy milk composition comprises at least about 1.5 g oleic acid per 100 g of soy yogurt composition. In some embodiments, the soy yogurt composition comprises at least about 2 g oleic acid per 100 g of soy yogurt composition. In some embodiments, the soy yogurt composition comprises between about 0.2 g and about 3 g oleic acid per 100 g of soy yogurt composition.

In some embodiments, the soy yogurt composition comprises at least about 10 mg, at least about 20 mg, at least about 30 mg, at least about 40 mg, or at least about 50 mg oleic acid per 1 g of soy solids. In certain embodiments, the soy yogurt composition comprises at least about 50 mg oleic acid per 1 g of soy solids. In some embodiments, the soy yogurt composition comprises between about 10 mg and about 100 mg oleic acid per 1 g of soy solids.

In other embodiments, the soy yogurt composition comprises at least about 30%, at least about 40%, at least about 50%, at least about 60%, or at least about 70% w/w oleic acid of the total fatty acid content. In certain embodiments, the soy yogurt composition comprises at least about 70% of oleic acid of the total fatty acid content.

### c) Raffinose and Stachyose Content

In some embodiments, the soy yogurt composition comprises less than or equal to about 60 mg, less than or equal to about 50 mg, less than or equal to about 40 mg, or less than or equal to about 30 mg raffinose per 100 g of soy yogurt composition. In certain embodiments, the soy yogurt composition comprises less than or equal to about 30 mg raffinose per 100 g of soy yogurt composition. In some embodiments, the soy yogurt composition comprises less than or equal to about 10 mg, less than or equal to about 9 mg, less than or equal to about 8 mg, less than or equal to about 7 mg raffinose per 1 g of soy solids. In certain embodiments, the soy yogurt composition comprises less than or equal to about 7 mg raffinose per 1 g of soy solids. In some embodiments, the soy yogurt composition comprises between about 0 mg and about 7 mg raffinose per 1 g of soy solids.

In some embodiments, the soy yogurt composition comprises less than or equal to about 300 mg, less than or equal to about 250 mg, less than or equal to about 200 mg, less than or equal to about 150 mg or less than or equal to about 100 mg stachyose per 100 g of soy yogurt composition. In certain embodiments, the soy yogurt composition comprises less than or equal to about 100 mg stachyose per 100 g of soy yogurt composition. In some embodiments, the soy yogurt composition comprises between about 0 mg and about 100 mg stachyose per 100 g of soy yogurt composition.

In some embodiments, the soy yogurt composition comprises less than or equal to about 20 mg, less than or equal to about 17 mg, less than or equal to about 15 mg, less than or equal to about 12 mg or less than or equal to about 10 mg stachyose per 1 g of soy solids. In certain embodiments, the soy yogurt composition comprises less than or equal to about 10 mg stachyose per 1 g of soy solids. In some embodiments, the soy yogurt composition comprises between about 0 mg and about 10 mg stachyose per 1 g of soy solids.

In certain other embodiments, the soy yogurt composition comprises less than or equal to about 7 mg raffinose per 1 g of soy solids and less than or equal to about 10 mg stachyose per 1 g of soy solids. In some embodiments, the soy yogurt composition comprises between about 0 mg and about 7 mg raffinose per 1 g of soy solids and between about 0 mg and about 10 mg stachyose per 1 g of soy solids.

In some embodiments, the soy yogurt composition comprises less than or equal to about 400 mg, less than or equal to about 350 mg, less than or equal to about 300 mg, less than or equal to about 250 mg, less than or equal to about 200 mg, or less than or equal to about 150 mg combined raffinose and stachyose per 100 g of soy yogurt composition. In certain embodiments, the soy yogurt composition comprises less than or equal to about 150 mg combined raffinose and stachyose per 100 g of soy yogurt composition. In some embodiments, the soy yogurt composition comprises between about 0 mg and about 150 mg combined raffinose and stachyose per 100 g of soy yogurt composition.

In other embodiments, the soy yogurt composition comprises less than or equal to about 40 mg, less than or equal to about 35 mg, less than or equal to about 30 mg, less than or equal to about 25 mg, or less than or equal to about 20 mg combined raffinose and stachyose per 1 g of soy solids. In certain other embodiments, the soy yogurt composition comprises less than or equal to about 20 mg combined raffinose and stachyose per 1 g of soy solids. In some embodiments, the soy yogurt composition comprises between about 0 mg and about 20 mg combined raffinose and stachyose per 1 g of soy solids.

### d) Total Glycitein Compounds and Other Flavor Components

In some embodiments, the soy yogurt composition comprises less than or equal to about 0.5 mg, less than or equal to about 0.45 mg, less than or equal to about 0.4 mg, less than or equal to about 0.35 mg, or less than or equal to about 0.3 mg total glycitein compounds per 100 g of soy yogurt composition. In certain embodiments, the soy yogurt composition comprises less than or equal to about 0.5 mg total glycitein compounds per 100 g of soy yogurt composition. In certain embodiments, the soy yogurt composition comprises less than or equal to about 0.075 mg, less than or equal to about 0.07 mg, less than or equal to about 0.065 mg, less than or equal to about 0.06 mg, less than or equal to about 0.055 mg, or less than or equal to about 0.05 mg total glycitein compounds per 1 g soy solids. In certain embodiments, the soy yogurt composition comprises less than or equal to about 0.05 mg total glycitein compounds per 1 g soy solids. In some embodiments, the soy yogurt composition comprises between about 0 mg and about 0.05 mg total glycitein compounds per 1 g soy solids.

In some embodiments, the soy yogurt composition comprises less than or equal to about 1 g, less than or equal to about 0.5 g, less than or equal to about 0.1 g lipoxygenase per 100 g of soy yogurt composition. In certain embodiments, the soy yogurt composition comprises less than or equal to about 1 g lipoxygenase per 100 g of soy yogurt composition. In other embodiments, the soy yogurt composition further comprises less than or equal to about 0.1 g, less than or equal to about 0.05 g or less than or equal to about 0.01 g lipoxygenase per 1 g soy solids. In certain other embodiments, the soy yogurt composition further comprises less than or equal to about 0.1 g lipoxygenase per 1 g soy solids. In some embodiments, the soy yogurt composition comprises between about 0 mg and about 0.1 g lipoxygenase per 1 g soy solids.

### e) Caloric Content

In some embodiments, the soy yogurt compositions of the present disclosure may be characterized by their caloric content per serving size. In some embodiments, a serving size is 100 g of soy yogurt composition.

### f) Sensory Characteristics

Similar to the soy milk compositions described herein, the soy yogurt compositions of the present disclosure may also be characterized by one or more sensory characteristic properties, including physical characteristics—e.g., color, grittiness, chalkiness, mouthfeel—and flavor characteristics.

The color of the soy yogurt compositions may be assessed visually or with reference to a standard color chart. As detailed herein, the soy yogurt compositions may be prepared from soybean varieties having hilum color that is yellow, white or clear. Light-colored hila are favored as they may result in lighter colored soy compositions downstream. In some embodiments, the soy yogurt composition of the present disclosure is white.

Textural or flavor characteristics of the soy yogurt compositions may be assessed by means of a formal tasting panel. In some embodiments, the presence or absence of one or more sensory attributes may be quantified on a numerical scale (e.g., 1 to 5 or 1 to 10) based on the perceived intensity of each flavor attribute, relative to a standard soy yogurt reference, such as a commercially available soy yogurt product.

In some embodiments, the soy yogurt compositions of the present disclosure may be characterized by the presence or absence of one or more sensory attributes including, for example, soy flavor/notes, nuttiness, butteriness, grassiness, smoothness, sweetness, oiliness, astringency, sharpness, bitterness, and sourness. In some variations, the soy yogurt compositions have one or more sensory attributes selected from the group consisting of: soy flavor/notes, nuttiness, butteriness, grassiness, smoothness, sweetness, oiliness, astringency, sharpness, bitterness, and sourness, and any combinations thereof.

### III. Soy Frozen Dessert Compositions

In one aspect, provided herein are soy frozen dessert compositions having high protein content. In another aspect, provided herein are soy frozen dessert compositions having 0.4 g soy protein per g of soy solids. In still yet another aspect, provided herein are soy frozen dessert compositions obtained by or obtainable from the methods of the present disclosure for producing soy frozen dessert compositions.

The soy frozen dessert compositions as provided herein have nutritional contents that directly reflect the source soybean varieties from which they were produced-including, for example, protein content, fat content, oligosaccharide content and other content. Accordingly, the soy frozen dessert compositions of the present disclosure may be characterized in terms of their protein content, fat content-including monounsaturated fat content, and more specifically oleic and linoleic acid content, raffinose and stachyose content, and total glycitein compounds content.

It should be recognized that compositions may be characterized in terms of content of any components per gram of soy solids, per unit volume (e.g., per ounce), per unit weight (e.g., per 100 grams of frozen dessert), or with reference to a certain serving size. In other embodiments, the compositions provided herein may be characterized in terms of ratios, e.g., the content of one component relative to the content of a second component.

### a) Protein Content

The present disclosure provides soy frozen dessert compositions having high protein content. In some embodiments, the soy frozen dessert composition comprises at least about 0.4 g, at least about 0.41 g, at least about 0.42 g, at least about 0.43 g, at least about 0.44 g, at least about 0.45 g, at least about 0.46 g, at least about 0.47 g, at least about 0.48 g, at least about 0.49 g, at least about 0.5 g, at least about 0.51 g, or at least about 0.52 g of soy protein per 1 g of soy solids. In certain embodiments, the soy frozen dessert composition comprises at least about 0.4 g, at least about 0.42 g, at least about 0.44 g, at least about 0.48 g, or at least about 0.5 g of soy protein per 1 g of soy solids. In certain embodiments, the soy frozen dessert composition comprises at least about 0.4 g of soy protein per 1 g of soy solids. In certain other embodiments, the soy frozen dessert composition comprises at least about 0.42 g of soy protein per 1 g of soy solids. In still other embodiments, the soy frozen dessert composition comprises at least about 0.44 g of soy protein per 1 g of soy solids. In yet certain other embodiments, the soy frozen dessert composition comprises at least about 0.48 g of soy protein per 1 g of soy solids. In still other embodiments, the soy frozen dessert composition comprises at least about 0.5 g of soy protein per 1 g of soy solids. In some embodiments, the soy frozen dessert composition comprises between about 0.4 g and about 0.8 g of soy protein per 1 g of soy solids.

In other embodiments, the soy frozen dessert composition comprises at least about 3 g, at least about 4 g, or at least about 5 g of soy protein per 100 g of soy frozen dessert composition. In some embodiments, the soy frozen dessert composition comprises at least about 5 g of soy protein per 100 g of soy frozen dessert composition. In some embodiments, the soy frozen dessert composition comprises between about 3 g and about 10 g of soy protein per 100 g of soy frozen dessert composition.

In some embodiments, at least about 70%, at least about 75%, at least about 80%, at least about 85%, at least about 90%, at least about 95%, at least about 99%, or about 100% of the protein in the soy frozen dessert composition is soy protein. In some embodiments, at least about 70%, at least about 75%, at least about 80%, at least about 85%, at least about 90%, at least about 95%, at least about 99%, or about 100% of the protein in the soy frozen dessert composition is derived from the soybeans used to prepare the soy frozen dessert composition. In some embodiments, the soy frozen dessert composition contains less than about 30%, less than about 25%, less than about 20%, less than about 15%, less than about 10%, less than about 5%, less than about 1%, or about 0% protein isolate by weight. In some embodiments, the soy frozen dessert composition contains less than about 30%, less than about 25%, less than about 20%, less than about 15%, less than about 10%, less than about 5%, less than about 1%, or about 0% soy protein isolate by weight.

The soy frozen dessert compositions as provided herein notably do not contain protein from external sources—including, for example, processed soy protein concentrates and/or protein isolates—beyond the source soybeans directly used to prepare the soy frozen dessert compositions.

In some embodiments, the protein present in the soy frozen dessert composition is protein obtained from the same source soybeans from which the oleic acid, raffinose, stachyose, and/or total glycitein compounds present in the soy frozen dessert composition were derived. In other embodiments, the soy frozen dessert composition is substantially free of soy protein concentrate or soy protein isolate. In still other embodiments, the soy frozen dessert composition is substantially free of protein obtained from non-soybean sources or soybean sources other than the soybeans from which the oleic acid, raffinose, stachyose, and/or total glycitein compounds present in the soy frozen dessert composition were derived.

### b) Fat Content

In some embodiments, the soy frozen dessert composition comprises at least about 10 mg, at least about 20 mg, at least about 30 mg, at least about 40 mg, or at least about 50 mg oleic acid per 1 g of soy solids. In certain embodiments, the soy frozen dessert composition comprises at least about 50 mg oleic acid per 1 g of soy solids. In some embodiments, the soy frozen dessert composition comprises between about 10 mg and about 100 mg oleic acid per 1 g of soy solids.

In other embodiments, the soy frozen dessert composition comprises at least about 30%, at least about 40%, at least about 50%, at least about 60%, or at least about 70% w/w oleic acid of the total fatty acid content. In certain embodiments, the soy frozen dessert composition comprises at least about 70% of oleic acid of the total fatty acid content.

### c) Raffinose and Stachyose Content

In some embodiments, the soy frozen dessert composition comprises less than or equal to about 10 mg, less than or equal to about 9 mg, less than or equal to about 8 mg, less than or equal to about 7 mg raffinose per 1 g of soy solids. In certain embodiments, the soy frozen dessert composition comprises less than or equal to about 7 mg raffinose per 1 g of soy solids. In some embodiments, the soy frozen dessert composition comprises between about 0 mg and about 7 mg raffinose per 1 g of soy solids.

In some embodiments, the soy frozen dessert composition comprises less than or equal to about 20 mg, less than or equal to about 17 mg, less than or equal to about 15 mg, less than or equal to about 12 mg or less than or equal to about 10 mg stachyose per 1 g of soy solids. In certain embodiments, the soy frozen dessert composition comprises less than or equal to about 10 mg stachyose per 1 g of soy solids. In some embodiments, the soy frozen dessert composition comprises between about 0 mg and about 10 mg stachyose per 1 g of soy solids.

In certain other embodiments, the soy frozen dessert composition comprises less than or equal to about 7 mg raffinose per 1 g of soy solids and less than or equal to about 10 mg stachyose per 1 g of soy solids. In some embodiments, the soy frozen dessert composition comprises between about 0 mg and about 7 mg raffinose per 1 g of soy solids and between about 0 mg and about 10 mg stachyose per 1 g of soy solids.

In other embodiments, the soy frozen dessert composition comprises less than or equal to about 40 mg, less than or equal to about 35 mg, less than or equal to about 30 mg, less than or equal to about 25 mg, or less than or equal to about 20 mg combined raffinose and stachyose per 1 g of soy solids. In certain other embodiments, the soy frozen dessert composition comprises less than or equal to about 20 mg combined raffinose and stachyose per 1 g of soy solids. In some embodiments, the soy frozen dessert composition comprises between about 0 gm and about 20 mg combined raffinose and stachyose per 1 g of soy solids.

### d) Total Glycitein Compounds and Other Flavor Components

In certain embodiments, the soy frozen dessert composition comprises less than or equal to about 0.075 mg, less than or equal to about 0.07 mg, less than or equal to about 0.065 mg, less than or equal to about 0.06 mg, less than or equal to about 0.055 mg, or less than or equal to about 0.05 mg total glycitein compounds per 1 g soy solids. In certain embodiments, the soy frozen dessert composition comprises less than or equal to about 0.05 mg total glycitein compounds per 1 g soy solids. In other embodiments, the soy frozen dessert composition further comprises less than or equal to about 0.1 g, less than or equal to about 0.05 g or less than or equal to about 0.01 g lipoxygenase per 1 g soy solids. In certain other embodiments, the soy frozen dessert composition further comprises less than or equal to about 0.1 g lipoxygenase per 1 g soy solids. In some embodiments, the soy frozen dessert composition comprises between about 0 g and about 0.1 g lipoxygenase per 1 g soy solids.

### e) Caloric Content

In some embodiments, the soy frozen dessert compositions of the present disclosure may be characterized by their caloric content per serving size. In some embodiments, a serving size is 100 g of soy frozen dessert composition. In other embodiments, the soy frozen dessert composition comprises less than or equal to about 200 Calories, less than or equal to about 175 Calories, less than or equal to about 150 Calories, or less than or equal to about 125 Calories per 100 g of soy frozen dessert composition. In some embodiments, the soy frozen dessert composition comprises less than or equal to about 125 Calories per 100 g of soy frozen dessert composition.

### f) Sensory Characteristics

Similar to the soy milk compositions described herein, the soy frozen dessert compositions of the present disclosure may also be characterized by one or more sensory characteristic properties, including physical characteristics—e.g., color, grittiness, chalkiness, mouthfeel—and flavor characteristics.

The color of the soy frozen dessert compositions may be assessed visually or with reference to a standard color chart. As detailed herein, the soy frozen dessert compositions may be prepared from soybean varieties having hilum color that is yellow, white or clear. Light-colored hila are favored as they may result in lighter colored soy compositions downstream. In some embodiments, the soy frozen dessert composition of the present disclosure is light yellow or white.

Textural or flavor characteristics of the soy frozen dessert compositions may be assessed by means of a formal tasting panel. In some embodiments, the presence or absence of one or more sensory attributes may be quantified on a numerical scale (e.g., 1 to 5 or 1 to 10) based on the perceived intensity of each flavor attribute, relative to a standard soy frozen dessert reference, such as a commercially available soy frozen dessert product.

In some embodiments of the present disclosure, the soy frozen dessert compositions of the present disclosure have a smooth mouthfeel and texture due to the high protein content. Without being bound by theory, it is believed that the high protein content of the soy milk composition used to prepare the corresponding soy frozen dessert compositions inhibits the formation of large ice crystals during churning and freezing. Accordingly, the soy frozen dessert compositions of the present disclosure may possess superior mouthfeel to other soy frozen desserts having lower protein contents.

In some embodiments, the soy frozen dessert compositions of the present disclosure have an average ice crystal size of no more than about 40 μm, no more than about 39 μm, no more than about 38 μm, no more than about 37 μm, no more than about 36 μm, no more than about 35 μm, or no more than about 34 μm.

In some embodiments, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, or at least about 75% of the ice crystals found in the soy frozen dessert compositions of the present disclosure are smaller than about 25 μm. In some embodiments, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, or at least about 75% of the ice crystals found in the soy frozen dessert compositions of the present disclosure are between about 26 μm and 40 μm. In some embodiments, less than about 5%, less than about 10%, less than about 15%, less than about 20%, less than about 25%, less than about 30%, less than about 35%, less than about 40%, less than about 45%, less than about 50%, less than about 55%, less than about 60%, less than about 65%, less than about 70%, or less than about 75% of the ice crystals found in the soy frozen dessert compositions of the present disclosure are between about 41 μm and 55 μm. In some embodiments, less about 5%, less than about 10%, less than about 15%, less than about 20%, less than about 25%, less than about 30%, less than about 35%, less than about 40%, less than about 45%, less than about 50%, less than about 55%, less than about 60%, less than about 65%, less than about 70%, or less than about 75% of the ice crystals found in the soy frozen dessert compositions of the present disclosure are larger than 55 μm.

In some embodiments, the soy frozen dessert compositions of the present disclosure comprise one or more additives to improve their texture. In some embodiments, the additive is a saturated fat. In some embodiments, the saturated fat is coconut oil.

In some embodiments, the soy frozen dessert compositions of the present disclosure may be characterized by the presence or absence of one or more sensory attributes including, for example, soy flavor/notes, nuttiness, butteriness, grassiness, smoothness, sweetness, oiliness, astringency, sharpness, bitterness, and sourness. In some variations, the soy frozen dessert compositions have one or more sensory attributes selected from the group consisting of: soy flavor/notes, nuttiness, butteriness, grassiness, smoothness, sweetness, oiliness, astringency, sharpness, bitterness, and sourness, and any combinations thereof.

### g) Full Nutritional Profile

In some embodiments, the soy frozen dessert compositions of the present disclosure comprise at least about 5 g of protein, less than about 3 g total fat, and less than about 15 g total sugars per 100 g of product. In some embodiments, the soy frozen dessert compositions of the present disclosure comprise at least about 5 g of protein, less than about 4 g total fat, and less than about 15 g total sugars per 100 g of product. In some embodiments, the soy frozen dessert compositions of the present disclosure comprise at least about 5 g of protein, less than about 5 g total fat, and less than about 15 g total sugars per 100 g of product.

In some embodiments, the soy frozen dessert compositions of the present disclosure comprise at least about 4 g of protein, less than about 3 g total fat, and less than about 15 g total sugars per 100 g of product. In some embodiments, the soy frozen dessert compositions of the present disclosure comprise at least about 3 g of protein, less than about 3 g total fat, and less than about 15 g total sugars per 100 g of product. In some embodiments, the soy frozen dessert compositions of the present disclosure comprise at least about 2 g of protein, less than about 3 g total fat, and less than about 15 g total sugars per 100 g of product.

In some embodiments, the soy frozen dessert compositions of the present disclosure comprise at least about 5 g of protein, less than about 3 g total fat, and less than about 16 g total sugars per 100 g of product. In some embodiments, the soy frozen dessert compositions of the present disclosure comprise at least about 5 g of protein, less than about 3 g total fat, and less than about 17 g total sugars per 100 g of product. In some embodiments, the soy frozen dessert compositions of the present disclosure comprise at least about 5 g of protein, less than about 3 g total fat, and less than about 18 g total sugars per 100 g of product. In some embodiments, the soy frozen dessert compositions of the present disclosure comprise at least about 5 g of protein, less than about 3 g total fat, and less than about 19 g total sugars per 100 g of product. In some embodiments, the soy frozen dessert compositions of the present disclosure comprise at least about 5 g of protein, less than about 3 g total fat, and less than about 20 g total sugars per 100 g of product.

### C. Other Food and Beverage Products

In certain aspects, provided are also food and beverage products incorporating or produced using the soy milk compositions, soy yogurt compositions and/or soy frozen dessert compositions having high protein content as described herein. As described herein the soy milk compositions of the present disclosure may be used to prepare soy yogurt and soy frozen dessert or similar frozen dessert compositions having high protein content. Such protein-enriched soy milk compositions, soy yogurt compositions and/or soy frozen dessert compositions as described herein may be used for protein fortification in various downstream food and beverage products, including for example, in juice based high acid beverages, allergen-free non-dairy low acid beverages, bakery products, baked snacks, cream soups, and cheese analogs.

In some embodiments, suitable food products may include, for example, soups, sauces, salad dressings, hummus, breads, cookies, crackers, nutritional bars, meal replacement products, and snacks. In some variations, the food product incorporating or produced from the soy milk compositions, soy yogurt compositions and/or soy frozen dessert compositions herein is a bakery product.

In some embodiments, beverages may include, for example, high-acid beverages, neutral beverages, carbonated beverages, non-carbonated beverages, high protein beverages, and meal replacement beverages.

As described herein, the properties of the soy milk compositions, soy yogurt compositions and/or soy frozen dessert compositions as described herein may be such that the soy milk compositions, soy yogurt compositions and/or soy frozen dessert compositions as described herein can used as ingredients in various food applications. The soy milk compositions, soy yogurt compositions and/or soy frozen dessert compositions as provided herein possess a number of favorable properties in addition to their high protein content, which makes them suitable for a wide-array of food and beverage products. With respect to certain applications, the soy milk compositions, soy yogurt compositions and/or soy frozen dessert compositions provided herein demonstrate superior properties as compared to other plant-based protein ingredients in the market (such as almond, oat and/or pea), and thus may be advantageously incorporated into specific food products over competitor non-dairy protein sources. Additional exemplary products that are contemplated may include, for example, beverage products such as ready-to-drink beverages or protein shake powders, drinkable plant-based yogurt.

The food and beverages products can include various other components other than the soy milk compositions, soy yogurt compositions and/or soy frozen dessert compositions as described herein. For example, the food and beverage products may include, for example, water, flour, fats and oils, sweeteners (such as sugar), salt, leavening agents, fruit and vegetable juices, thickeners (such as corn syrup, pectin and other hydrocolloids), anti-foaming agents, natural and artificial flavorings, preservatives, and coloring agents.

In another aspect, provided is a method of preparing food and/or beverages products comprising a soy milk composition, a soy yogurt composition and/or a soy frozen dessert composition as described herein. Such methods may include one or more of mixing/blending, pasteurizing and/or sterilizing, baking, fermenting, carbonating, leavening, and packaging.

Reference to “about” a value or parameter herein includes (and describes) embodiments that are directed to that value or parameter per se. For example, description referring to “about X” includes description of “X”. In some embodiments, the term “about” when used in association with a measurement, or used to modify a value, a unit, a constant, or a range of values, refers to variations of +/−2%.

Reference to “between” two values or parameters herein includes (and describes) embodiments that include those two values or parameters per se. For example, description referring to “between x and y” includes description of “x” and “y” per se.

### ENUMERATED EMBODIMENTS

The following enumerated embodiments are representative of some aspects of the invention.

Embodiment 1. A soy milk composition, comprising:
(I) at least about 4 g of soy protein per 100 mL of liquid volume; and
(II) at least one of (i)-(vi):
   (i) at least 0.5 g oleic acid per 100 mL of liquid volume;
   (ii) less than or equal to about 30 mg of raffinose per 100 mL of liquid volume;
   (iii) less than or equal to about 100 mg of stachyose per 100 mL of liquid volume; and
   (iv) less than or equal to about 0.5 mg total glycitein compounds per 100 mL of liquid volume.

Embodiment 2. The soy milk composition of embodiment 1, comprising at least about 0.5 g oleic acid per 100 mL of liquid volume.

Embodiment 3. The soy milk composition of embodiment 1 or 2, comprising at least about 1 g oleic acid per 100 mL of liquid volume.

Embodiment 4. The soy milk composition of any one of embodiments 1-3, comprising at least about 2 g oleic acid per 100 mL of liquid volume.

Embodiment 5. The soy milk composition of any one of embodiments 1-4, comprising at least about 70% w/w oleic acid of the total fatty acid content.

Embodiment 6. The soy milk composition of any one of embodiments 1-5, having:
(i) less than or equal to about 30 mg raffinose per 100 mL of liquid volume;
(ii) less than or equal to about 100 mg stachyose per 100 mL of liquid volume; or
(iii) both (i) and (ii).

Embodiment 7. The soy milk composition of any one of embodiments 1-6, comprising less than or equal to about 30 mg of raffinose per 100 mL of liquid volume and less than or equal to about 100 mg of stachyose per 100 mL of liquid volume.

Embodiment 8. The soy milk composition of any one of embodiments 1-7, comprising less than or equal to about 0.5 mg total glycitein compounds per 100 mL of liquid volume.

Embodiment 9. The soy milk composition of any one of embodiments 1-8, comprising less than or equal to about 1 g lipoxygenase per 100 mL of liquid volume.

Embodiment 10. The soy milk composition of any one of embodiments 1-9, wherein the soy milk composition is white.

Embodiment 11. The soy milk composition of any one of embodiments 1-10, comprising at least about 4.2 g of soy protein per 100 mL of liquid volume.

Embodiment 12. The soy milk composition of any one of embodiments 1-11, comprising at least about 4.4 g of protein per 100 mL of liquid volume.

Embodiment 13. The soy milk composition of any one of embodiments 1-12, comprising at least about 4.8 g of protein per 100 mL of liquid volume.

Embodiment 14. The soy milk composition of any one of embodiments 1-13, comprising at least about 5 g of soy protein per 100 mL of liquid volume.

Embodiment 15. The soy milk composition of any one of embodiments 1-14, wherein the soy protein present in the soy milk composition is soy protein obtained from the same source soybeans from which the oleic acid, raffinose, stachyose, and/or total glycitein compounds present in the soy milk composition were derived.

Embodiment 16. The soy milk composition of any one of embodiments 1-15, wherein the soy milk composition is substantially free of soy protein concentrate or soy protein isolate.

Embodiment 17. The soy milk composition of any one of embodiments 1-16, wherein the soy milk composition is substantially free of protein obtained from non-soybean sources or soybean sources other than the soybeans from which the oleic acid, raffinose, stachyose, and/or total glycitein compounds present in the soy milk composition were derived.

Embodiment 18. A soy milk composition, comprising:
(i) less than or equal about 130 calories per 8 fluid ounces;
(ii) at least about 13 g of protein per 8 fluid ounces; and
(iii) at least about 4 g of monounsaturated fats per 8 fluid ounces.

Embodiment 19. A soy milk composition, comprising:
(i) less than or equal to about 80 calories per 8 fluid ounces;
(ii) at least about 8 g of protein per 8 fluid ounces; and
(iii) at least about 4 g of monounsaturated fats per 8 fluid ounces.

Embodiment 20. A method of producing a soy milk composition, comprising:
a) providing soybeans, wherein the soybeans comprise at least about 40% soy protein on a dry weight basis;
b) drying, and optionally cracking, the soybeans to provide dried soybeans;
c) dehulling the dried soybeans to provide soy grits;
d) grinding the soy grits in hot water to provide a soy slurry;
e) heating the soy slurry;
f) cooling the soy slurry; and
g) filtering the soy slurry, thereby providing the soy milk composition, wherein the soy milk composition comprises at least about 0.4 g of soy protein per 1 g of soy solids.

Embodiment 21. The method of embodiment 20, wherein the dried soybeans have a moisture content of less than or equal to about 10% w/w.

Embodiment 22. The method of embodiment 20 or 21, wherein the temperature of the hot water combined with the soy grits is at least about 80° C.

Embodiment 23. The method of any one of embodiments 20-22, wherein the soy grits are combined with the hot water at a weight ratio of water-to-soy grits of between about 5:1 and about 10:1.

Embodiment 24. The method of any one of embodiments 20-23, wherein the soy slurry is heated to a temperature of at least about 80° C.

Embodiment 25. The method of any one of embodiments 20-24, wherein the soy slurry is cooled to room temperature.

Embodiment 26. The method of any one of embodiments 20-25, wherein t the soy milk composition does not contain particles greater than or equal to about 75 μm.

Embodiment 27. The method of any one of embodiments 20-26, wherein the soy milk composition further comprises at least about 10 mg oleic acid per 1 g of soy solids.

Embodiment 28. The method of any one of embodiments 20-27, wherein the soy milk composition further comprises at least about 70% w/w oleic acid of the total fatty acid content.

Embodiment 29. The method of any one of embodiments 20-28, wherein the soy milk composition further comprises:
(i) less than or equal to about 7 mg raffinose per 1 g of soy solids;
(ii) less than or equal to about 10 mg stachyose per 1 g of soy solids; or
(iii) both (i) and (ii).

Embodiment 30. The method of any one of embodiments 20-29, wherein the soy milk composition further comprises less than or equal to about 0.05 mg total glycitein compounds per 1 g soy solids.

Embodiment 31. The method of any one of embodiments 20-30, wherein the soy milk composition further comprises less than or equal to about 0.1 g lipoxygenase per 1 g soy solids.

Embodiment 32. The method of any one of embodiments 20-31, wherein the soybeans further comprise yellow, white or clear hila.

Embodiment 33. The method of any one of embodiments 20-32, wherein the soybeans comprise at least about 42% soy protein on a dry weight basis and the soy milk composition comprises 0.42 g soy protein per 1 g soy solids.

Embodiment 34. The method of any one of embodiments 20-33, wherein the soybeans comprise at least about 44% soy protein on a dry weight basis and the soy milk composition comprises 0.44 g soy protein per 1 g soy solids.

Embodiment 35. The method of any one of embodiments 20-34, wherein the soybeans comprise at least about 48% soy protein on a dry weight basis and the soy milk composition comprises 0.48 g soy protein per 1 g soy solids

Embodiment 36. The method of any one of embodiments 20-35, wherein the soybeans comprise at least about 50% soy protein on a dry weight basis and the soy milk composition comprises 0.5 g soy protein per 1 g soy solids.

Embodiment 37. A soy milk composition obtained by or obtainable from the method according to any one of embodiments 20-36.

Embodiment 38. A method of preparing a soy yogurt composition, comprising:
a) providing a soy milk composition according to any one of embodiments 1-19 and 37, or obtained according to the method of any one of embodiments 20-36,
b) heating the soy milk composition to provide a heated soy milk composition;
c) cooling the heated soy milk composition;
d) adding a bacterial starter culture, and optionally a coagulant, to the heated soy milk composition to provide soy culture mixture;
e) incubating the soy culture mixture at an incubation temperature for a suitable time to provide a fermented soy composition; and
f) straining the fermented soy composition to remove excess liquid, thereby providing the soy yogurt composition.

Embodiment 39. The method of embodiment 38, wherein the soy milk composition is heated to a temperature of between about 70° C. and about 90° C.

Embodiment 40. The method of embodiment 38 or 39, wherein the soy milk composition is incubated at a temperature of between about 40° C. and about 50° C.

Embodiment 41. The method of any one of embodiments 38-40, wherein the soy milk composition is incubated for a period of between about 3 hours and about 12 hours.

Embodiment 42. A soy yogurt composition obtained by or obtainable from the method according to any one of embodiments 38-41.

Embodiment 43. A method of preparing a soy frozen dessert composition, comprising:
a) providing a soy milk composition according to any one of embodiments 1-19 and 37, or obtained according to the method of any one of embodiments 20-36,
b) combining the soy milk composition with sugar, a thickening agent, and optionally one or more flavoring agents, to provide a frozen dessert base mixture;
c) heating the frozen dessert base mixture to provide a heated frozen dessert base mixture;
d) chilling the heated frozen dessert base mixture, optionally straining the heated frozen dessert base mixture prior to chilling, to provide a chilled frozen dessert base mixture; and
e) churning the chilled frozen dessert base mixture at a suitable time and temperature to provide a soy frozen dessert composition.

Embodiment 44. The method of embodiment 43, comprising heating the frozen dessert base mixture to a temperature of between about 30° C. and about 90° C.

Embodiment 45. The method of embodiment 43 or 44, comprising chilling the frozen dessert base mixture at a temperature of less than or equal to about 10° C.

Embodiment 46. The method of any one of embodiments 43-45, comprising churning the frozen dessert base at a temperature of less than or equal to about 4° C.

Embodiment 47. The method of embodiment 46, further comprising freezing the churned frozen dessert base mixture.

Embodiment 48. A soy frozen dessert composition obtained by or obtainable from the method according to any one of embodiments 43-47.

Embodiment 49. A food product, a beverage product, a dietary supplement product or other product, comprising the soy milk composition according to any one of embodiments 1-19 and 37 or obtained by or obtainable from the method according to any one of embodiments 20-36.

Embodiment 50. The product of embodiment 49, is a non-dairy food product or beverage product.

Embodiment 51. The product of embodiment 50, wherein the beverage product is a fruit smoothie, a meal replacement beverage, a protein drink, an instant shake, or drinkable yogurt.

Embodiment 52. The product of embodiment 49, wherein the food product is yogurt or a frozen dessert, or non-dairy cheese.

### EXAMPLES

The presently disclosed subject matter will be better understood by reference to the following Examples, which are provided as exemplary of the invention, and not by way of limitation.

### Example 1A: Preparation of Soy Milk Composition

This example details an exemplary method for the preparation of soy milk according to the present disclosure.

High protein soybeans with a protein content of 36-51% (seed, dry-basis) are cleaned to remove foreign matter and loose hulls. The whole soybeans are then heated to remove excess moisture. The dried beans are cracked and dehulled to remove the skin covering the soybeans and produce soy grits. The resulting soy grits are ground in hot water (80° C.) to produce a soy slurry.

Following the grinding process, the soy slurry is boiled and stirred to deactivate undesirable enzymes and remove volatile, unsavory flavor compounds. Once the slurry is cooled to room temperature, it is filtered to separate undispersed fiber residue. The liquid is collected from the filter to afford soy milk.

This general process for producing soy milk was varied in each of the below embodiments to optimize the desired characteristics of each composition. Different soybean varieties and/or ratios of hot water to beans during the soy grit grinding step were used to optimize characteristics such as soy milk protein levels, flavor profiles, and thickness. Additional considerations include other sensory attributes, soymilk yield, soybean inclusion, and other nutritional values such as lipids and fatty acids, sugars and oligosaccharides, fibers, and minerals.

### Example 1B: Preparation of Soy Milk Compositions from High Protein Soybean Varieties

This example describes the production of soy milk compositions from five different source soybean varieties having high protein content as compared to commodity soybeans. The protein content of whole soybean, protein content of dehulled soybean, crude fat content, stachyose content, raffinose content, and total glycitein compounds content as weight percentages of the soybean (% w/w, on a dry basis) for each soybean variety are shown in Table 6.

The protein content of the resulting soy milk compositions was adjusted by altering ratio of hot water to dehulled soybeans (soy grits). The ratio of hot water to dehulled soybeans was modulated from between 5:1 to 10:1. Samples of the soy milk compositions prepared from the soybean varieties of Table 6 were freeze-dried and subjected to composition analysis in Tables 7A-7C. As shown in Table 7A, lower water to dehulled soybean ratios resulted in higher protein content in grams per individual serving size for the resulting soy milk compositions. Despite low volumes of water added to the dehulled soybeans, the soy milk compositions prepared from the high protein soybean varieties yielded as high as 15 g of protein per serving as compared commercially available soymilk (7 g protein per serving).

TABLE 6
Soybean Varieties

| | Whole Bean | | | Oleic | | | Stachyose | |
|---|---|---|---|---|---|---|---|---|
| | Protein | Dehulled | Crude | acid | | | and | Total |
| Bean | Content | Protein | Fat | (dry- | Stachyose | Raffinose | Raffinose | glycitein |
| Variety | (dry- | (dry- | (dry- | basis, | (dry- | (dry- | (dry- | compounds |
| No. | basis) | basis) | basis) | estimated) | basis) | basis) | hasis) | (mg/kg) |
| Commodity | 39.3% | 41.8% | 23.2% | 5.3% | 4.37% | 1.21% | 5.57% | 169 |
| Soybean | | | | | | | | |
| Soybean | 40.8% | 42.1% | 20.5% | 14.6% | 4.07% | 0.72% | 4.79% | 213 |
| Variety #1 | | | | | | | | |
| Soybean | 43.5% | 45.2% | 19.9% | 15.0% | 0.39% | 0.39% | 0.78% | 224 |
| Variety #2 | | | | | | | | |
| Soybean | 44.0% | 46.2% | 20.8% | 3.5% | 3.85% | 0.79% | 4.64% | 262 |
| Variety #3 | | | | | | | | |
| Soybean | 45.8% | 48.7% | 20.8% | 3.6% | 0.51% | 0.64% | 1.15% | 205 |
| Variety #4 | | | | | | | | |
| Soybean | 48.2% | 51.0% | 17.3% | 3.2% | 4.13% | 0.90% | 5.02% | 299 |
| Variety #5 | | | | | | | | |

TABLE 7A

| | | Protein | | | | | | |
|---|---|---|---|---|---|---|---|---|
| Soybean | Water to | (g)/8 | Grams (g) per 100 mL Soy Milk | | | | | |
| Variety | dehulled | fl. oz. | | Total | Oleic | Total | | |
| No. | bean Ratio | Serving | Protein | Lipid | acid | sugars | Sucrose | Raffinose |
| Commercial | n/a | 7.0 | 3.11 | 1.81 | 0.42 | 0.64 | 0.60 | 0.06 |
| Soy Milk | | | | | | | | |
| Commodity | 6.00 | 15.0 | 6.23 | 3.66 | 0.84 | 1.05 | 1.00 | 0.21 |
| Soybean | 8.00 | 9.0 | 3.91 | 1.71 | 0.39 | 0.67 | 0.64 | 0.14 |
| Soybean | 5.00 | 14.0 | 5.84 | 3.48 | 2.47 | 1.20 | 1.14 | 0.14 |
| Variety #1 | 7.30 | 10.0 | 4.16 | 1.92 | 1.36 | 0.87 | 0.82 | 0.10 |
| Soybean | 5.00 | 15.0 | 6.33 | 3.47 | 2.62 | 1.68 | 1.68 | 0.01 |
| Variety #2 | 7.90 | 10.0 | 4.25 | 1.75 | 1.32 | 1.09 | 1.09 | 0.01 |
| Soybean | 6.00 | 14.0 | 5.91 | 2.37 | 0.40 | 0.85 | 0.80 | 0.11 |
| Variety #3 | 8.50 | 10.0 | 4.20 | 1.25 | 0.21 | 0.64 | 0.59 | 0.10 |
| Soybean | 6.00 | 15.0 | 6.26 | 2.67 | 0.46 | 1.05 | 1.03 | <0.01 |
| Variety #4 | 8.70 | 10.0 | 4.25 | 1.10 | 0.19 | 0.70 | 0.68 | 0.01 |
| Soybean | 6.00 | 15.0 | 6.32 | 2.78 | 0.51 | 0.77 | 0.71 | 0.12 |
| Variety #5 | 8.90 | 10.0 | 4.27 | 1.18 | 0.22 | 0.61 | 0.54 | 0.07 |

| | Grams (g) per 100 mL Soy Milk | | | | |
|---|---|---|---|---|---|
| | | | | | Total |
| Soybean | | | | | Glycitein |
| Variety | | Saturated | Monounsaturated | Polyunsaturated | Compounds |
| No. | Stachyose | fatty acid | fatty acid | fatty acid | (mg) |
| Commercial | 0.33 | 0.21 | 0.42 | 1.04 | 0.55 |
| Soy Milk | | | | | |
| Commodity | 0.81 | 0.59 | 0.84 | 2.23 | 1.02 |
| Soybean | 0.54 | 0.27 | 0.39 | 1.04 | 0.48 |
| Soybean | 0.80 | 0.39 | 2.47 | 0.62 | 2.66 |
| Variety #1 | 0.57 | 0.21 | 1.36 | 0.34 | 1.77 |
| Soybean | 0.07 | 0.37 | 2.62 | 0.48 | 1.97 |
| Variety #2 | 0.05 | 0.19 | 1.32 | 0.24 | 1.25 |
| Soybean | 0.56 | 0.39 | 0.40 | 1.58 | 0.75 |
| Variety #3 | 0.48 | 0.20 | 0.21 | 0.83 | 0.68 |
| Soybean | 0.05 | 0.43 | 0.46 | 1.77 | N/A |
| Variety #4 | 0.04 | 0.18 | 0.19 | 0.73 | 0.59 |
| Soybean | 0.63 | 0.44 | 0.51 | 1.83 | 2.42 |
| Variety #5 | 0.39 | 0.19 | 0.22 | 0.78 | 1.89 |

TABLE 7B

| | | | | | | | | Milk Raffinose | |
|---|---|---|---|---|---|---|---|---|---|
| | | Milk Protein | | Milk Raffinose | | Milk Stachyose | | and Stachyose | |
| | Seed | | g/g soy | | mg/g soy | | mg/g soy | | mg/g soy |
| | Protein | dry-basis, | solids, | dry-basis, | solids, | dry-basis, | solids, | dry-basis, | solids, |
| Variety | dry-basis | actual | actual | actual | actual | actual | actual | actual | actual |
| Commodity | 39.29% | 43.9% | 0.44 | 1.53% | 15.3 | 5.9% | 58.5 | 7.4% | 73.9 |
| Soybean | | | | | | | | | |
| Soybean | 40.84% | 44.6% | 0.45 | 1.04% | 10.4 | 6.1% | 60.9 | 7.1% | 71.3 |
| Variety #1 | | | | | | | | | |
| Soybean | 43.46% | 47.8% | 0.48 | 0.06% | 0.6 | 0.5% | 5.4 | 0.6% | 6.0 |
| Variety #2 | | | | | | | | | |
| Soybean | 43.96% | 49.5% | 0.50 | 1.04% | 10.4 | 5.2% | 52.0 | 6.2% | 62.3 |
| Variety #3 | | | | | | | | | |
| Soybean | 45.77% | 52.6% | 0.53 | 0.07% | 0.7 | 0.5% | 4.6 | 0.5% | 5.3 |
| Variety #4 | | | | | | | | | |
| Soybean | 48.23% | 54.1% | 0.54 | 0.98% | 9.8 | 5.2% | 51.9 | 6.2% | 61.6 |
| Variety #5 | | | | | | | | | |

TABLE 7C

| | | Protein | | | | | Milk Total | |
|---|---|---|---|---|---|---|---|---|
| Soybean | Water | (g)/8 | Milk Lipid | | Milk Oleic Acid | | Glycitein Compounds | |
| Variety | to dehulled | fl. oz. | %, dry- | g/g soy | %, dry- | mg/g soy | dry-basis, | dry-basis, |
| No. | bean Ratio | Serving | basis | solids | basis | solids | mg/kg | mg/g |
| Commercial | n/a | 7.0 | 26.3% | 0.26 | 6.0% | 60 | 79.8 | 0.080 |
| Soy Milk | | | | | | | | |
| Commodity | 6.00 | 15.0 | 25.9% | 0.26 | 5.9% | 59 | 72.2 | 0.072 |
| Soybean | 8.00 | 9.0 | 19.1% | 0.19 | 4.4% | 44 | 53.7 | 0.054 |
| Soybean | 5.00 | 14.0 | 26.4% | 0.26 | 18.7% | 187 | 202.1 | 0.20 |
| Variety #1 | 7.30 | 10.0 | 20.7% | 0.21 | 14.7% | 147 | 190.8 | 0.19 |
| Soybean | 5.00 | 15.0 | 25.7% | 0.26 | 19.4% | 194 | 146.3 | 0.15 |
| Variety #2 | 7.90 | 10.0 | 20.0% | 0.20 | 15.1% | 151 | 142.5 | 0.14 |
| Soybean | 6.00 | 14.0 | 20.0% | 0.20 | 3.3% | 33 | 63.5 | 0.064 |
| Variety #3 | 8.50 | 10.0 | 14.6% | 0.15 | 2.4% | 24 | 79.7 | 0.080 |
| Soybean | 6.00 | 15.0 | 22.8% | 0.23 | 3.9% | 39 | N/A | N/A |
| Variety #4 | 8.70 | 10.0 | 13.4% | 0.13 | 2.3% | 23 | 72.0 | 0.072 |
| Soybean | 6.00 | 15.0 | 23.8% | 0.24 | 4.4% | 44 | 207.5 | 0.21 |
| Variety #5 | 8.90 | 10.0 | 14.9% | 0.15 | 2.7% | 27 | 238.5 | 0.24 |

### Example 1C: Comparison of Exemplary Soy Milk Compositions to Commercial Dairy and Plant-Based Milks

The plant-based dairy marketplace contains low protein products, dairy equivalent products, and protein premium products. As shown in Table 8 below, protein premium products typically contain more calories than dairy equivalent products on a per serving basis (8 fluid ounces). Table 8 further shows an exemplary soy milk composition that could be obtained from a high protein soybean variety as described in Example 1B. Soy milk compositions as generally described in Example 1B offer a plant-based dairy product with higher protein than dairy equivalents or almond- or oat-based products while containing comparable or even fewer calories than other dairy equivalent and premium protein products.

TABLE 8

| | | | | | | | Exemplary Soy | | |
|---|---|---|---|---|---|---|---|---|---|
| | | | 2% | | Standard | Dairy | Milk from | Soy | Pea |
| | Almond | Oat | Cow | Pea | Soy | 2% | High Protein | Protein | Protein |
| | Milk | Milk | Milk | Milk | Milk | Milk | Soybean variety | Shake | Shake |
| Protein (g) | 1 | 1 | 8 | 8 | 8 | 13 | 13 | 20 | 20 |
| per serving | | | | | | | | | |
| Calories | 60 | 120 | 120 | 100 | 110 | 120 | 130 | 160 | 200 |
| (Cal) per | | | | | | | | | |
| serving | | | | | | | | | |
| Fat (g) per | 2.5 | 5 | 5 | 4.5 | 4.5 | 4.5 | 4.5 | 5 | 7 |
| serving | | | | | | | | | |
| Sugar (g) | 7 | 7 | 12 | 6 | 5 | 6 | 5 | 5 | 9 |
| per serving | | | | | | | | | |

### Example 2: Preparation of Exemplary Soy Yogurt Composition

The present example describes an exemplary process for preparing soy yogurt as described herein.

Cooked soy milk is prepared according to the protocol in Example 1. The soy milk is heated to a temperature in the range of 70-90° C. to sterilize/pasteurize the soy milk. The heated soy milk is allowed to cool to a temperature of about 40-50° C. At this temperature, a starter bacterial (yogurt) culture is added. A coagulant, such as rennet, may be added at this time to facilitate thickening of the yogurt. The yogurt culture, and coagulant, are stirred into the cooled soy milk to mix. Once mixed, the mixture is left to incubate at a temperature of about 40-50° C. for between 3-12 hours to taste.

After incubation, the resulting soy yogurt is allowed to cool to room temperature and is optionally strained to remove unwanted liquid.

### Example 3: Preparation of Exemplary Soy Frozen Dessert Composition and Tasting Panel

This example details the preparation of soy frozen dessert as one embodiment of the invention. Soy frozen dessert was made using soy milk produced generally in accordance with the process described in Example 1B.

The soymilk produced from Soybean Variety #4 was identified as having low levels of unpleasant flavors. Multiple soy milk compositions using this variety were then made by varying the ratio of hot water to soy beans between 5:1 and 9:1 during the soy grit grinding step described in Example 1. These various processing conditions produced soy milks having between 10 g and 17 g of protein in an 8 fluid ounce serving. The soy milk with 15 g of protein per 8 fluid ounce serving was selected for use in the exemplary soy frozen dessert.

White granulated sugar (56 g), white corn syrup (46 g), table salt (⅛ tsp, <1 g), and vanilla bean (half of whole vanilla bean) were combined with the soy milk (474 mL) in a saucepan. The mixture was heated to below-simmering to ensure each of the ingredients had fully dissolved. The cooled mixture was chilled in the refrigerator for 24 hours to thicken the frozen dessert base. The resulting base was strained through a fine-mesh strainer to remove any remaining solid pieces. The frozen dessert base was then churned in an ice cream maker for 20 minutes to produce a frozen dessert. The resulting frozen dessert was frozen for approximately 18 hours before being sampled.

The nutritional information of the prepared dessert, shown in Table 9, was determined based on the known nutritional information from each ingredient. The dessert contained 5 g of protein per 100 g, comparable to a commercially available dairy ice cream and 2.5-5 times greater than commercially available plant-based frozen desserts. Use of the high-protein soy milk resulted in the soy frozen dessert having 5 g of protein without the addition of protein isolate.

TABLE 9

| | | | | | | Dairy | Dairy | Dairy |
|---|---|---|---|---|---|---|---|---|
| | Exemplary | Commercial | Almond | Oat | Pea | Ice | Ice | Ice |
| | Soy Milk | Soy Frozen | Frozen | Frozen | Frozen | Cream | Cream | Cream |
| per 100 g | from High | dessert #1 | dessert | dessert | dessert | #1 | #2 | #3 |
| Protein (g) | 5 | 2 | 1 | 1 | 2 | 5 | 7 | 8 |
| Calories (Cal) | 111 | 154 | 157 | 210 | 227 | 205 | 116 | 139 |
| Total Fat (g) | 2.1 | 3.8 | 7.9 | 13.0 | 12.7 | 10.2 | 2.3 | 6.5 |
| Total Sugars (g) | 14 | 15 | 17 | 00 | 00 | 22 | 00 | 13 |

The dessert also contained only 2.1 g of fat, all originating from the soy milk. No other fat-containing ingredients were added. The frozen dessert had a total caloric content of 111 Calories per 100 g of frozen dessert, and contained 14 g of total sugars.

The soy frozen dessert prepared above was provided to a tasting panel to assess the texture properties of the soy frozen dessert. The participants described the dessert as having a “sorbet-like texture”. They also found the soy frozen dessert lacked the large ice crystals that are typically expected in low-fat desserts that are made without the addition of gums or other gelling agents that inhibit crystal formation. The high protein level of the soymilk resulted in the fine-crystal texture of the soy frozen dessert that was achieved without the incorporation of additional fats or gelling agents.

### Example 4: Flavor Characteristic Tasting Panel

The flavor sensory characteristics may be assessed by way of a formal tasting panel composed of a number (e.g., 6) of trained tasting individuals. The participants are asked to perform free choice profiling by blindly tasting each soy composition sample in duplicate and assigning attributes that they believe best describe the flavor of each sample. Once completed, the data is pooled and the most frequently mentioned sample descriptors are analyzed in the sensory evaluation.

The panelists record the intensity of each sensory characteristic on a 15-point scale, where 0=no intensity and 15=extreme intensity. Soy composition samples were tasted shortly after and evaluated in the same manner compared to the control—the control soy sample is a commercially available soy milk, soy yogurt, or soy frozen dessert depending upon the samples being evaluated. Room temperature water is served to rinse the palate between samples.

### Example 5: Flavor Characteristic Tasting Panel

### Methods and Results

The flavor sensory characteristics of several soy milks were assessed by way of a formal tasting panel composed of a number (e.g., 6) of trained tasting individuals. The soy milks tested included soy milks prepared from commodity soybeans and soybean varieties #1-5 as described in Example 1. All soy milks tested were prepared to have a protein content of 15 g of protein per serving. The participants were asked to perform free choice profiling by blindly tasting each soy milk sample in duplicate and assigning attributes that they believed best describe the flavor of each sample. Once completed, the data was pooled and the most frequently mentioned sample descriptors were analyzed in the sensory evaluation.

The panelists recorded the intensity of each sensory characteristic on a 15-point scale, where 0=no intensity and 15=extreme intensity. Soy milk samples were tasted shortly after and evaluated in the same manner compared to the control—the control soy sample is a commercially available soy milk. Room temperature water was served to rinse the palate between samples.

Overall liking of the soy milks was assessed by way of a consumer tasting panel composed of a number of untrained tasting individuals (e.g. over 100 panelists) who were screened for soy milk purchasing and consumption habits. The soy milks tested included soy milks prepared from commodity soybeans and soybean varieties #1-5 as described in Example 1. All soy milks tested were prepared to have a protein content of 15 g of protein per serving. The participants were asked to blindly taste each soy milk sample and score each soy milk on a 9-point hedonic scale, where 1=Dislike Extremely, 2=Dislike Very Much, 3=Dislike Moderately, 4=Dislike Slightly, 5=Neither Like nor Dislike, 6=Like Slightly, 7=Like Moderately, 8=Like Very Much, and 9=Like Extremely. Once completed, the data were pooled and overall liking was averaged for each soy milk.

For each flavor sensory characteristic that panelists ranked, the Pearson correlation between the characteristic assessed by the trained individual panelists and the untrained consumer panelists' overall liking of the soy milks was calculated. The Pearson correlation method is a method commonly used for quantifying correlations between numerical variables. The method assigns a value between −1 and 1, where 0 denotes no correlation, 1 denotes total positive correlation, and −1 denotes total negative correlation. Table 10, below, summarizes the Pearson correlation between each flavor sensory characteristic and panelists' overall liking of the soy milks. Notably, a strong negative correlation was observed between umami flavor and overall liking. In contrast, a positive correlation was observed between sweetness and overall liking.

TABLE 10

| | Pearson Correlation with |
|---|---|
| Characteristic | Overall Liking |
| Overall Liking | 1.00 |
| Sweet | 0.53 |
| Viscosity | 0.34 |
| Chalky | 0.08 |
| Beany | 0.07 |
| Sweet_AR | 0.05 |
| Astringent | −0.09 |
| Brothy | −0.12 |
| Grassy | −0.18 |
| Cereal | −0.38 |
| Bitter | −0.52 |
| Cooked Nutty | −0.57 |
| Aftertaste | −0.67 |
| Overall Flavor Impact | −0.77 |
| Umami* | −0.91 |
| Overall Aroma Impact* | −0.91 |

*95% confidence interval does not include zero

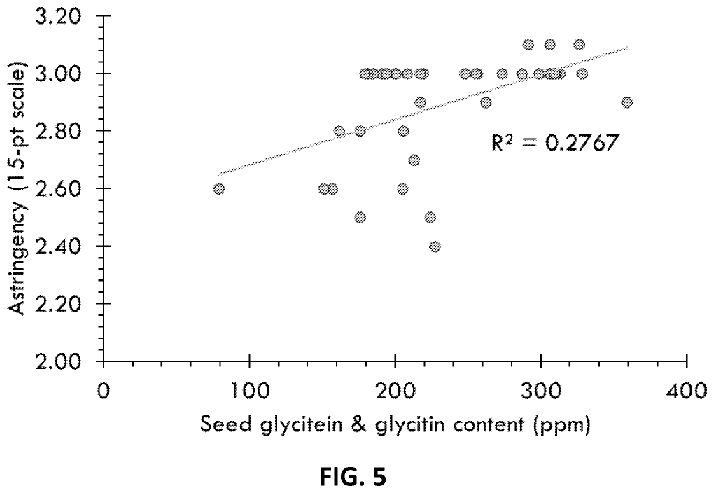

Astringency was measured as a sensory characteristic by the trained individual panelists. Astringency was defined as a drying-out, roughening, and puckery sensation felt in the mouth upon tasting the soy milk. Surprisingly, the astringency of a soy milk was found to positively correlate with the concentration of glycitein or glycitin, both isoflavone compounds, in the seeds of the soybean variety from which the soy milk was produced. A plot summarizing astringency vs. seed glycitein and glycitin content is provided as FIG. 5.

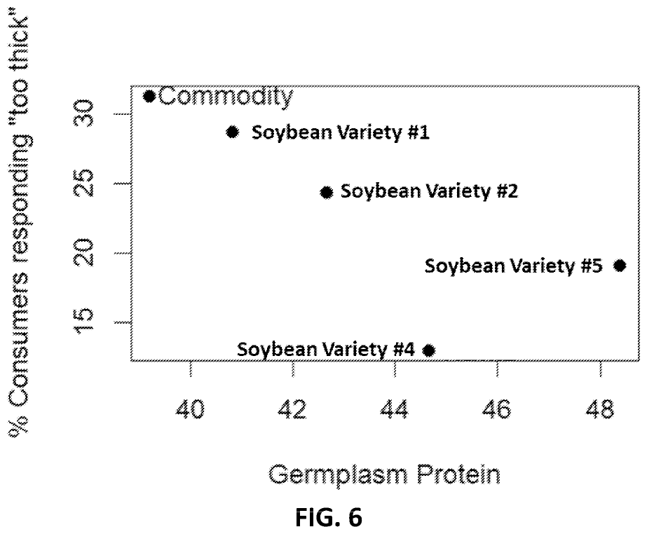

For soy milks prepared from soybeans having lower germplasm protein levels, a higher inclusion rate, or bean-to-water ratio, was needed to prepare a soy milk having 15 g of protein per serving. During testing, untrained consumer panelists were asked to comment on whether each soy milk was “not thick enough”, “just about right”, or “too thick”. Thickness preference was determined by use of a Just About Right (JAR) scale, where participants were asked to blindly taste each soy milk sample and score each soymilk on a 5-point JAR scale, where 1=Not Nearly Thick Enough, 2=Not Thick Enough, 3=Just About Right, 4=Too Thick, and 5=Much Too Thick. The percent of consumers designating a soy milk as a 1 or 2 on the JAR scale were summed to produce a single “Not Thick Enough” percent value. The percent of consumers designating a soy milk as a 4 or 5 were summed to produce a single “Too Thick” percent value. Penalty analysis was performed to determine whether overall liking decreased among consumers who designated soy milks as Not Thick Enough, or as Too Thick. Only soy milks with at least 20% of consumers designating the sample as Not Thick Enough or as Too Thick were analyzed for a mean drop in overall liking. Three of the five soy milks tasted were designated “Too Thick” by 24.3%-31.3% of consumers, and this was found to result in a mean overall liking drop of 0.8-1.4 points on a 9-point hedonic liking scale relative to the consumers who designated soy milk thickness “Just About Right”. The proportion of panelists that described a particular soy milk as “too thick” was observed to inversely correlate with the germplasm protein content of the soybean variety used to prepare the milk. A plot summarizing this finding is provided as FIG. 6.

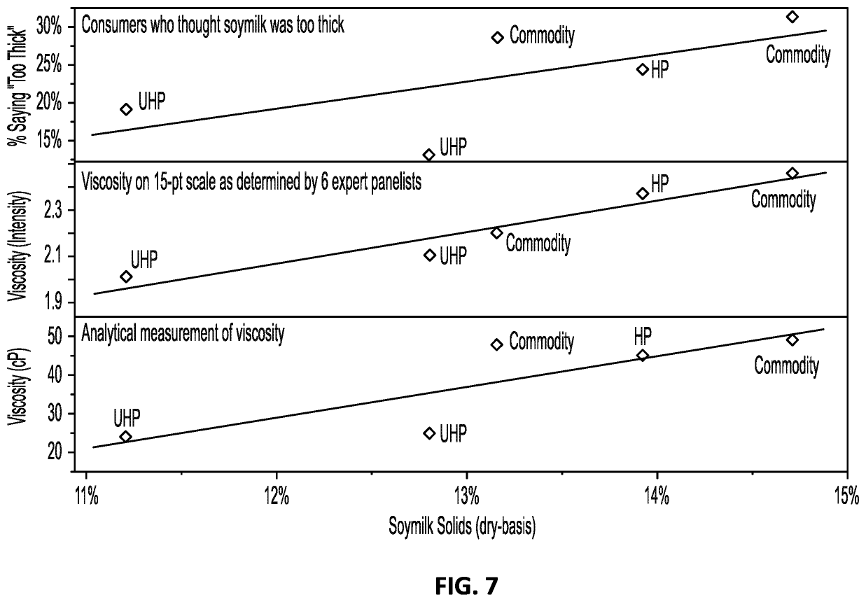

Additionally, it was also found that the inclusion of a higher proportion of soy solids per unit liquid volume in the soy milks was correlated to both perceived viscosity (as assessed by a trained tasting panel) and physical viscosity (as measured in centipoise). Further, the percentage of untrained consumers describing a soy milk as “too thick” (as described above) was also found to positively correlate to the proportion of soy solids per unit liquid volume in the soy milks tested. A set of plots summarizing these findings is provided as FIG. 7.

### DISCUSSION

As discussed above, a positive correlation was found between soy milk sweetness and panelists' overall liking of the soy milk. Because oligosaccharides like raffinose and stachyose are less sweet the disaccharide sucrose, soy milks having a high raffinose or stachyose content may be perceived as less sweet than soy milks having similar overall carbohydrate content, but with a lower raffinose or stachyose content. Accordingly, soy milk compositions having low raffinose and/or stachyose contents may exhibit desirable flavor properties.

Further, it was surprisingly found that the flavor characteristic of “umami” in soy milk was strongly correlated with a low overall liking of the soy milk. Accordingly, soy milk compositions that are characterized by the absence of the sensory characteristic of umami may be desirable to consumers. In some variations, “umami” refers to the fundamental taste sensation elicited by monosodium glutamate (MSG), but may also be associated with other free amino acids and certain 5′ nucleotides.

Additionally, it was surprisingly found that the sensory flavor characteristic of astringency was positively correlated with the amount of glycitein and glycitin found in the seeds of the soybeans used to prepare each soy milk. In other words, soy milks prepared from soybean varieties with higher concentrations of glycitein and glycitin in their seeds were perceived as more astringent. Astringency may be perceived as an undesirable characteristic in soy milk by consumers. Accordingly, in soy milk compositions having low concentrations of glycitein and glycitin may have flavor sensory characteristics that are desirable to consumers.

What is claimed is:

1. A soy milk composition, comprising:
(I) at least about 4 g of soy protein per 100 mL of liquid volume; and
(II) at least one of (i)-(vi):
(i) at least 0.5 g oleic acid per 100 mL of liquid volume;
(ii) less than or equal to about 30 mg of raffinose per 100 mL of liquid volume;
(iii) less than or equal to about 100 mg of stachyose per 100 mL of liquid volume;
(iv) less than or equal to about 0.5 mg total glycitein compounds per 100 mL of liquid volume; and
(v) less than about 15 g of soy solids per 100 mL of liquid volume, or any combination thereof.

2. The soy milk composition of claim 1, comprising at least about 0.5 g oleic acid per 100 mL of liquid volume.

3. The soy milk composition of claim 1 or 2, comprising at least about 70% w/w oleic acid of the total fatty acid content.

4. The soy milk composition of any one of claims 1-5, having:
(i) less than or equal to about 30 mg raffinose per 100 mL of liquid volume;
(ii) less than or equal to about 100 mg stachyose per 100 mL of liquid volume; or
(iii) both (i) and (ii).

5. The soy milk composition of any one of claims 1-4, comprising less than or equal to about 0.5 mg total glycitein compounds per 100 mL of liquid volume.

6. The soy milk composition of any one of claims 1-5, comprising at least about 4.2 g of soy protein per 100 mL of liquid volume.

7. The soy milk composition of any one of claims 1-6, wherein the soy protein present in the soy milk composition is soy protein obtained from the same source soybeans from which the oleic acid, raffinose, stachyose, and/or total glycitein compounds present in the soy milk composition were derived.

8. The soy milk composition of any one of claims 1-7, wherein the soy milk composition is substantially free of soy protein concentrate or soy protein isolate.

9. The soy milk composition of any one of claims 1-8, wherein the soy milk composition is substantially free of protein obtained from non-soybean sources or soybean sources other than the soybeans from which the oleic acid, raffinose, stachyose, and/or total glycitein compounds present in the soy milk composition were derived.

10. The soy milk composition of any one of claims 1-9, wherein the soy milk composition is prepared from a soybean variety that has a glycitein and/or glycitin content of less than about 230 ppm in the seeds of the soybeans.

11. The soy milk composition of any one of claims 1-10, wherein the soy milk composition has one or more of the following:
(i) a glutamic acid concentration that is less than about 10 μM;
(ii) an aspartic acid concentration that is less than about 11 μM;
(iii) a histidine concentration that is less than about 1.6 μM; or
(iv) an arginine concentration that is less than about 39 μM.

12. The soy milk composition of claim 11, wherein the soy milk composition has all of the following:
(i) a glutamic acid concentration that is less than about 10 μM;
(ii) an aspartic acid concentration that is less than about 11 μM;
(iii) a histidine concentration that is less than about 1.6 μM; and
(iv) an arginine concentration that is less than about 39 μM.

13. The soy milk composition of any one of claims 1-12, having:
(i) at least about 4 g of protein per 100 mL of liquid volume;
(ii) less than or equal to 30 mg of raffinose per 100 mL of liquid volume;
(iii) less than or equal to 100 mg of stachyose per 100 mL of liquid volume;
(iv) less than about 15 g of soy solids per 100 mL of liquid volume; and
(v) less than or equal to about 0.5 mg total glycitein compounds per 100 mL of liquid volume.

14. The soy milk composition of claim 13, further having:
(i) a glutamic acid concentration that is less than about 10 μM;
(ii) an aspartic acid concentration that is less than about 11 μM;
(iii) a histidine concentration that is less than about 1.6 μM; and
(iv) an arginine concentration that is less than about 39 μM.

15. The soy milk composition of any one of claims 1-14, comprising between about 11 g and 13 g of soy solids per 100 mL of liquid volume.

16. The soy milk composition of any one of claims 1-15, wherein the soy milk composition has a viscosity between about 20 cP and about 40 cP.

17. A soy milk composition, comprising:
(i) less than or equal about 130 calories per 8 fluid ounces;
(ii) at least about 13 g of protein per 8 fluid ounces; and
(iii) at least about 4 g of monounsaturated fats per 8 fluid ounces.

18. A soy milk composition, comprising:
(i) less than or equal to about 80 calories per 8 fluid ounces;
(ii) at least about 8 g of protein per 8 fluid ounces; and
(iii) at least about 4 g of monounsaturated fats per 8 fluid ounces.

19. A soy milk composition, comprising:
(i) about 140 calories per 8 fluid ounces;
(ii) about 15 g of protein per 8 fluid ounces;
(iii) about 6 g of fat; and
(iv) about 3 g of sugar.

20. A method of producing a soy milk composition, comprising:
a) providing soybeans, wherein the soybeans comprise at least about 40% soy protein on a dry weight basis;
b) drying, and optionally cracking, the soybeans to provide dried soybeans;
c) dehulling the dried soybeans to provide soy grits;
d) grinding the soy grits in hot water to provide a soy slurry;
e) heating the soy slurry;
f) cooling the soy slurry; and
g) filtering the soy slurry, thereby providing the soy milk composition, wherein the soy milk composition comprises at least about 0.4 g of soy protein per 1 g of soy solids.

21. The method of claim 20, wherein the dried soybeans have a moisture content of less than or equal to about 10% w/w.

22. The method of claim 20 or 21, wherein the temperature of the hot water combined with the soy grits is at least about 80° C.

23. The method of any one of claims 20-22, wherein the soy grits are combined with the hot water at a weight ratio of water-to-soy grits of between about 5:1 and about 10:1.

24. The method of any one of claims 20-23, wherein the soy slurry is heated to a temperature of at least about 80° C.

25. The method of any one of claims 20-24, wherein the soy slurry is cooled to room temperature.

26. The method of any one of claims 20-35, wherein the soy milk composition does not contain particles greater than or equal to about 75 μm.

27. The method of any one of claims 20-27, wherein the soy milk composition further comprises at least about 10 mg oleic acid per 1 g of soy solids.

28. The method of any one of claims 20-28, wherein the soy milk composition further comprises at least about 70% w/w oleic acid of the total fatty acid content.

29. The method of any one of claims 20-29, wherein the soy milk composition further comprises:
(i) less than or equal to about 7 mg raffinose per 1 g of soy solids;
(ii) less than or equal to about 10 mg stachyose per 1 g of soy solids; or
(iii) both (i) and (ii).

30. The method of any one of claims 20-29, wherein the soy milk composition further comprises less than or equal to about 0.05 mg total glycitein compounds per 1 g soy solids.

31. The method of any one of claims 20-30, wherein the soy milk composition further comprises less than or equal to about 0.1 g lipoxygenase per 1 g soy solids.

32. The method of any one of claims 20-31, wherein the soybeans further comprise yellow, white or clear hila.

33. The method of any one of claims 20-32, wherein the soybeans comprise at least about 42% soy protein on a dry weight basis and the soy milk composition comprises 0.42 g soy protein per 1 g soy solids.

34. The method of any one of claims 20-33, wherein the seeds of the soybeans comprise less than 230 ppm glycitein and/or glycitin.

35. A soy milk composition obtained by or obtainable from the method according to any one of claims 20-34.

36. A method of preparing a soy yogurt composition, comprising:
a) providing a soy milk composition according to any one of claims 1-19 and 35, or obtained according to the method of any one of claims 20-34,
b) heating the soy milk composition to provide a heated soy milk composition;
c) cooling the heated soy milk composition;
d) adding a bacterial starter culture, and optionally a coagulant, to the heated soy milk composition to provide soy culture mixture;
e) incubating the soy culture mixture at an incubation temperature for a suitable time to provide a fermented soy composition; and
f) straining the fermented soy composition to remove excess liquid, thereby providing the soy yogurt composition.

37. The method of claim 36, wherein the soy milk composition is heated to a temperature of between about 70° C. and about 90° C.

38. The method of claim 36 or 37, wherein the soy milk composition is incubated at a temperature of between about 40° C. and about 50° C.

39. The method of any one of claims 36-38, wherein the soy milk composition is incubated for a period of between about 3 hours and about 12 hours.

40. A soy yogurt composition obtained by or obtainable from the method according to any one of claims 37-39.

41. A method of preparing a soy frozen dessert composition, comprising:
a) providing a soy milk composition according to any one of claims 1-19 and 35, or obtained according to the method of any one of claims 20-34,
b) combining the soy milk composition with sugar, a thickening agent, and optionally one or more flavoring agents, to provide a frozen dessert base mixture;
c) heating the frozen dessert base mixture to provide a heated frozen dessert base mixture;
d) chilling the heated frozen dessert base mixture, optionally straining the heated frozen dessert base mixture prior to chilling, to provide a chilled frozen dessert base mixture; and
e) churning the chilled frozen dessert base mixture at a suitable time and temperature to provide a soy frozen dessert composition.

42. The method of claim 41, comprising heating the frozen dessert base mixture to a temperature of between about 30° C. and about 90° C.

43. The method of claim 41 or 42, comprising chilling the frozen dessert base mixture at a temperature of less than or equal to about 10° C.

44. The method of any one of claims 41-43, comprising churning the frozen dessert base at a temperature of less than or equal to about 4° C.

45. The method of claim 44, further comprising freezing the churned frozen dessert base mixture.

46. A soy frozen dessert composition obtained by or obtainable from the method according to any one of claims 41-45.

47. A food product, a beverage product, a dietary supplement product or other product, comprising the soy milk composition according to any one of claims 1-9 and 35 or obtained by or obtainable from the method according to any one of claims 20-34.

48. The product of claim 47, wherein the product is a non-dairy food product or beverage product.

49. The product of claim 48, wherein the beverage product is a fruit smoothie, a meal replacement beverage, a protein drink, an instant shake, or drinkable yogurt.

50. The product of claim 47, wherein the food product is yogurt or a frozen dessert, or non-dairy cheese.
